(19) United States
(12) Patent Application Publication
(10) Pub. No.: US 2026/0204577 A1
(43) Pub. Date: Jul. 16, 2026

(54) BINDER FOR SECONDARY BATTERY ELECTRODES, USE OF SAME, AND METHOD FOR PRODUCING BINDER FOR SECONDARY BATTERY ELECTRODES

(71) Applicant: TOAGOSEI CO., LTD., Tokyo (JP)

(72) Inventors: Masaki SHIMADA, Nagoya-shi, Aichi (JP); Naohiko SAITO, Nagoya-shi, Aichi (JP); Shinya KANBE, Nagoya-shi, Aichi (JP); Takashi HASEGAWA, Nagoya-shi, Aichi (JP)

(73) Assignee: TOAGOSEI CO., LTD., Tokyo (JP)

(21) Appl. No.: 19/137,569

(22) PCT Filed: Dec. 14, 2023
(86) PCT No.: PCT/JP2023/044786

§ 371 Date: Jun. 10, 2025

(30) Foreign Application Priority Data
Dec. 21, 2022 (JP) 2022-204992

(51) Int. Cl. H01M 4/62; H01M 10/0525

(52) U.S. Cl. CPC H01M 4/622; H01M 10/0525

(57) ABSTRACT

The present invention provides a binder for secondary battery electrodes capable of exhibiting excellent binding property with an active material even in an electrolytic solution and exhibiting a high capacity retention rate by having good electrolytic solution swelling resistance while maintaining flexibility as compared with a conventional case. In addition, provided are a composition for a secondary battery electrode mixture layer containing the binder, and a secondary battery electrode and a secondary battery obtained using the composition. A binder for secondary battery electrodes containing an emulsion containing a block polymer having a polymer block (A) and a polymer block (B), in which the polymer block (A) contains a structural unit derived from an ethylenically unsaturated carboxylic acid monomer, and the polymer block (B) contains a structural unit derived from a (meth)acrylic acid ester monomer having a solubility of less than 1 g in 100 g of water at 20° C.

### TECHNICAL FIELD

The present invention relates to a binder for secondary battery electrodes, a composition for a secondary battery electrode mixture layer, a secondary battery electrode and a secondary battery, and a method for producing a secondary battery electrode binder.

### BACKGROUND ART

As the secondary battery, various power storage devices such as a nickel-hydrogen secondary battery, a lithium ion secondary battery, and an electric double layer capacitor have been put into practical use. Electrodes used in these secondary batteries are prepared by, for example, applying and drying a composition for forming an electrode mixture layer containing an active material, a binder, and the like onto a current collector. For example, in the lithium ion secondary battery, an aqueous binder containing styrene-butadiene rubber (SBR) latex and carboxymethyl cellulose (CMC) is used as a binder used in a composition for a negative electrode mixture layer. Further, as a binder excellent in dispersibility and binding property, a binder containing an aqueous solution or an aqueous dispersion of an acrylic acid-based polymer is known. On the other hand, as a binder used for a positive electrode mixture layer, an N-methyl-2-pyrrolidone (NMP) solution of polyvinylidene fluoride (PVDF) is widely used.

On the other hand, as applications of various secondary batteries expand, demands for improvement in energy density, reliability, and durability tend to increase. For example, specifications using a silicon-based active material as an active material for a negative electrode have been increasing for the purpose of increasing electric capacity of the lithium ion secondary battery. However, it is known that the silicon-based active material has a large volume change during charging and discharging, and there has been a problem that peeling, falling off, or the like of the electrode mixture layer occurs as the silicon-based active material is repeatedly used, and as a result, the capacity of the battery decreases, and cycle characteristics (durability) deteriorate. In order to suppress such a problem, it is generally effective to enhance the binding property of the binder, and for the purpose of improving durability, studies on improvement of the binding property of the binder have been conducted.

As a binder having good binding properties and having an effect of improving durability, a binder using the acrylic acid-based polymer has been proposed. Patent Literature 1 describes that by using a polymer obtained by crosslinking polyacrylic acid with a specific crosslinking agent as a binder, it is possible to provide an electrode having an electrode structure that is not destroyed even when an active material containing silicon is used.

Patent Literature 2 describes a binder for a lithium battery including a block copolymer having a segment containing a structural unit compatible with an electrolytic solution and a segment containing a structural unit incompatible with the electrolytic solution, and describes that the binder exhibits a high capacity retention rate even when charging and discharging are repeated. In addition, Patent Literature 3, in which a binder using a block polymer is studied for the purpose of improving performance such as binding property, discloses a binder containing a block copolymer having a segment containing a structural unit of a vinyl monomer having an acid component and a segment containing a structural unit of a (meth)acrylic acid alkyl ester monomer.

### CITATION LIST

### Patent Literature

Patent Literature 1: WO 2014/065407 A
Patent Literature 2: WO 2015/163302 A
Patent Literature 3: JP-A-2012-204303

### SUMMARY OF INVENTION

### Problems to be Solved by Invention

The binder disclosed in Patent Literature 1 can impart good electrolytic solution swelling resistance, but has insufficient cycle characteristics due to insufficient flexibility of the binder.

Each of the binders disclosed in Patent Literatures 2 and 3 can impart good binding properties, but can impart good binding properties in a dry coating film state, however, since the binder contains a component that is likely to be compatible with an electrolytic solution of an active material, the binder has a problem that active material binding properties under immersion in the electrolytic solution are insufficient, the active material slips during charging and discharging, and the capacity retention rate is likely to deteriorate. Here, the “electrolytic solution swelling” refers to a ratio at which the binder absorbs the electrolytic solution, and the good electrolytic solution swelling resistance means that the electrolytic solution swelling is low and a ratio at which the binding property of the binder decreases in the electrolytic solution is small.

The present invention has been made in view of such circumstances, and an object of the present invention is to provide a binder for secondary battery electrodes capable of exhibiting excellent binding property with the active material even in the electrolytic solution and exhibiting a high capacity retention rate by having good electrolytic solution swelling resistance while maintaining flexibility as compared with a conventional case. In addition, another object of the present invention is to provide a composition for a secondary battery electrode mixture layer containing the binder, and a secondary battery electrode and a secondary battery obtained using the composition.

### Solution to Problems

As a result of intensive studies to solve the above problems, the present inventors have found that a binder for secondary battery electrodes containing an emulsion containing a block polymer having: a polymer block (A) containing a structural unit derived from an ethylenically unsaturated carboxylic acid monomer; and a polymer block (B) containing a structural unit derived from a (meth)acrylic acid ester monomer (hereinafter, also referred to as “monomer (b)”) having a solubility of less than 1 g in 100 g of water at 20° C. can exhibit a charge/discharge capacity retention rate superior to the conventional case by retaining high binding properties and suppressing swelling during immersion in the electrolytic solution, and have completed the present invention.

The present invention is as follows.
[1] A binder for secondary battery electrodes containing an emulsion containing a block polymer having a polymer block (A) and a polymer block (B), in which the polymer block (A) contains a structural unit derived from an ethylenically unsaturated carboxylic acid monomer, and the polymer block (B) contains a structural unit derived from a (meth)acrylic acid ester monomer (hereinafter, also referred to as “monomer (b)”) having a solubility of less than 1 g in 100 g of water at 20° C.
[2] The binder for secondary battery electrodes according to [1], in which a ratio of the polymer block (A) in the block polymer is 1 mass % or more and 50 mass % or less.
[3] The binder for secondary battery electrodes according to [1] or [2], in which the polymer block (A) contains a structural unit derived from an ethylenically unsaturated carboxylic acid monomer in an amount of 50 mass % or more with respect to all structural units of the polymer block (A).
[4] The binder for secondary battery electrodes according to any one of [1] to [3], in which the polymer block (B) contains a structural unit derived from the monomer (b) in an amount of 50 mass % or more with respect to all structural units of the polymer block (B).
[5] The binder for secondary battery electrodes according to any one of [1] to [4], in which the block polymer does not contain a structural unit derived from a crosslinkable monomer.
[6] The binder for secondary battery electrodes according to any one of [1] to [5], in which the block polymer is a salt obtained by neutralizing 40 mol % or more of carboxyl groups of the block polymer.
[7] The binder for secondary battery electrodes according to any one of [1] to [6], in which a particle size of the emulsion is 100 to 800 nm as a value measured by a laser diffraction/scattering method.
[8] A composition for a secondary battery electrode mixture layer, the composition containing the binder for secondary battery electrodes according to any one of [1] to [7], an active material, and water.
[9] A secondary battery electrode including a mixture layer formed from the composition for the secondary battery electrode mixture layer according to [8] on a surface of a current collector.
[10] A secondary battery including the secondary battery electrode according to [9].
[11] A method for producing a secondary battery electrode binder containing an emulsion containing a block polymer, in which the block polymer has a polymer block (A) and a polymer block (B), and the method includes: a step of producing the polymer block (A) by polymerizing a monomer component containing an ethylenically unsaturated carboxylic acid monomer by a living radical polymerization method; and a step of producing the polymer block (B) by performing emulsion polymerization of a monomer component containing a (meth)acrylic acid ester monomer having a solubility of less than 1 g in 100 g of water at 20° C. in the presence of the polymer block (A).
[12] The method for producing the secondary battery electrode binder according to [11], in which the living radical polymerization method is a reversible addition-fragmentation chain transfer polymerization method (RAFT method).
[13] The method for producing the secondary battery electrode binder according to [11] or [12], in which the emulsion polymerization is soap-free polymerization.

### Effects of Invention

According to the binder for secondary battery electrodes of the present invention, since the binding property to the active material is excellent even in the electrolytic solution by suppressing the electrolytic solution swelling to a certain level or less, the cycle characteristics can be improved as compared with the conventional case.

### DESCRIPTION OF EMBODIMENTS

A binder for secondary battery electrodes of the present invention contains an emulsion containing a block polymer, and can be mixed with an active material and water to be a composition for a secondary battery electrode mixture layer (hereinafter, also referred to as “the present composition”). The above composition may be in a slurry state capable of being applied to a current collector, or may be prepared in a wet powder state, so as to be able to cope with press working on a surface of the current collector. The secondary battery electrode according to the present invention is obtained by forming a mixture layer formed of the above composition on the surface of the current collector such as a copper foil or an aluminum foil.

Hereinafter, each of the binder for secondary battery electrodes, the composition for the secondary battery electrode mixture layer, the secondary battery electrode, and a secondary battery, which are obtained using the binder of the present invention will be described in detail.

Note that in the present specification, “(meth)acryl” means acryl and/or methacryl, and “(meth)acrylate” means acrylate and/or methacrylate. Further, a “(meth)acryloyl group” means an acryloyl group and/or a methacryloyl group.

### 1. Binder

The binder for secondary battery electrodes of the present invention is the emulsion containing the block polymer (hereinafter, also referred to as “the present block polymer”). The present block polymer has a polymer block (A) containing a structural unit derived from an ethylenically unsaturated carboxylic acid monomer and a polymer block (B) containing a structural unit derived from a monomer (b).

The present block polymer preferably does not contain a structural unit derived from a crosslinkable monomer from the viewpoint of improving flexibility of the binder, binding the active material and the binder in a wider area, and improving binding strength. Here, examples of the crosslinkable monomer include a polyfunctional polymerizable monomer having two or more polymerizable unsaturated groups, N-methylol (meth)acrylamide, and a monomer having a self-crosslinkable functional group such as a hydrolyzable silyl group.

Hereinafter, the present block polymer will be described in detail.

### <Polymer Block (A)>

The polymer block (A) is a polymer block containing the structural unit derived from the ethylenically unsaturated carboxylic acid monomer, and can be obtained, for example, by polymerizing a monomer composition containing the ethylenically unsaturated carboxylic acid monomer. When the present block polymer has a carboxyl group by having such a structural unit, adhesiveness to the current collector is improved, and a lithium ion desolvation effect and ion conductivity are excellent, so that an electrode having low resistance and excellent high-rate characteristics can be obtained.

Examples of the ethylenically unsaturated carboxylic acid monomer include: (meth)acrylic acid, itaconic acid, crotonic acid, maleic acid, fumaric acid; (meth)acrylamidoalkyl carboxylic acid such as (meth)acrylamidohexanoic acid and (meth)acrylamidododecanoic acid; and ethylenically unsaturated monomers having a carboxyl group, such as succinic acid monohydroxyethyl (meth)acrylate, @-carboxy-caprolactone mono(meth)acrylate, and β-carboxyethyl (meth)acrylate, and (partially) alkali-neutralized products thereof, and one of them may be used alone, or two or more thereof may be used in combination. Among the above, a compound having an acryloyl group is preferable, and acrylic acid is particularly preferable as a polymerizable functional group, in that a polymer having a long primary chain length is obtained due to a high polymerization rate, and binding force of the binder is improved. When acrylic acid is used as the ethylenically unsaturated carboxylic acid monomer, a polymer having a high carboxyl group content can be obtained.

In the polymer block (A), the content of the structural unit derived from the ethylenically unsaturated carboxylic acid monomer based on all structural units of the polymer block (A) is not particularly limited, but is, for example, 1 mass % or more and 100 mass % or less, for example, 30 mass % or more and 100 mass % or less, for example, 50 mass % or more and 100 mass % or less, for example, 60 mass % or more and 100 mass % or less, or for example, 70 mass % or more and 100 mass % or less. By containing the structural unit derived from the ethylenically unsaturated carboxylic acid monomer within such a range, excellent adhesiveness to the current collector can be easily secured. When a lower limit of the structural unit derived from (meth)acrylic acid is 50 mass % or more, electrolytic solution swelling resistance of a binder coating film is improved, which is more preferable.

Further, the polymer block (A) may contain a structural unit derived from a monomer (hereinafter, also referred to as “monomer (a)”) other than the ethylenically unsaturated carboxylic acid monomer, and is not particularly limited.

Examples of the monomer (a) include an aromatic vinyl monomer, a maleimide compound, a (meth)acrylic acid ester monomer, (meth)acrylamide and derivatives thereof, and a nitrile group-containing ethylenically unsaturated monomer. An amount of each monomer used is, for example, 50 mass % or less, for example, 40 mass % or less, for example, 30 mass % or less, for example, 20 mass % or less, or for example, 10 mass % or less with respect to a total amount of monomers constituting the polymer block (A).

Examples of the aromatic vinyl monomer include styrene, α-methylstyrene, vinylnaphthalene, and isopropenylnaphthalene, and one of them may be used alone, or two or more thereof may be used in combination.

Examples of the maleimide compound include maleimide and an N-substituted maleimide compound. Examples of the N-substituted maleimide compound include: N-alkyl-substituted maleimide compounds such as N-methylmaleimide, N-ethylmaleimide, N-n-propylmaleimide, N-isopropylmaleimide, N-n-butylmaleimide, N-isobutylmaleimide, N-tert-butylmaleimide, N-pentylmaleimide, N-hexylmaleimide, N-heptylmaleimide, N-octylmaleimide, N-laurylmaleimide, and N-stearylmaleimide; N-cycloalkyl-substituted maleimide compounds such as N-cyclopentylmaleimide and N-cyclohexylmaleimide; N-aryl-substituted maleimide compounds such as N-phenylmaleimide, N-(4-hydroxyphenyl) maleimide, N-(4-acetylphenyl) maleimide, N-(4-methoxyphenyl) maleimide, N-(4-ethoxyphenyl) maleimide, N-(4-chlorophenyl) maleimide, N-(4-bromophenyl) maleimide, and N-benzylmaleimide, and one or more of them can be used.

Examples of the (meth)acrylic acid ester monomer include: (meth)acrylic acid alkyl ester compounds such as methyl (meth)acrylate, ethyl (meth)acrylate, butyl (meth)acrylate, isobutyl (meth)acrylate, and 2-ethylhexyl (meth)acrylate;
aromatic (meth)acrylic acid ester compounds such as phenyl (meth)acrylate, phenylmethyl (meth)acrylate, phenylethyl (meth)acrylate, and phenoxyethyl (meth)acrylate;
(meth)acrylic acid alkoxyalkyl ester compounds such as 2-methoxyethyl (meth)acrylate and ethoxyethyl (meth)acrylate; and
(meth)acrylic acid hydroxyalkyl ester compounds such as hydroxyethyl (meth)acrylate, hydroxypropyl (meth)acrylate, and hydroxybutyl (meth)acrylate, and one of them may be used alone, or two or more thereof may be used in combination.

Examples of the (meth)acrylamide derivatives include: N-alkyl (meth)acrylamide compounds such as isopropyl (meth)acrylamide and t-butyl (meth)acrylamide; N-Alkoxyalkyl (meth)acrylamide compounds such as N-n-butoxymethyl (meth)acrylamide and N-isobutoxymethyl (meth)acrylamide; N,N-dialkyl (meth)acrylamide compounds such as dimethyl (meth)acrylamide and diethyl (meth)acrylamide; and cyclic (meth)acrylamide compounds such as 4-acryloylmorpholine, and one of them may be used alone, or two or more thereof may be used in combination.

Examples of the nitrile group-containing ethylenically unsaturated monomer include: (meth)acrylonitrile; cyanoalkyl (meth)acrylate ester compounds such as cyanomethyl (meth)acrylate and cyanoethyl (meth)acrylate; cyano group-containing unsaturated aromatic compounds such as 4-cyanostyrene and 4-cyano-α-methylstyrene; and vinylidene cyanide, and one of them may be used alone, or two or more thereof may be used in combination.

A number average molecular weight (Mn) of the polymer block (A) is not particularly limited, but is preferably in a range of 1,000 or more and 1 million or less. When the number average molecular weight is 1,000 or more, it can exhibit high cohesive strength as the binder to contribute to improving binding properties of the electrode. Further, when the number average molecular weight is 1 million or less, it is preferable in that good fluidity can be secured and handling during production and the like is easy. The number average molecular weight of the block polymer (A) is preferably 5,000 or more, more preferably 8,000 or more, still more preferably 10,000 or more, and even still more preferably 20,000 or more. Further, an upper limit of the number average molecular weight is preferably 800,000 or less, more preferably 750,000 or less, still more preferably 500,000 or less, and even still more preferably 350,000 or less.

Molecular weight distribution (Mw/Mn) obtained by dividing a value of a weight average molecular weight (Mw) of the polymer block (A) by a value of the number average molecular weight (Mn) is not particularly limited, but is preferably 3.0 or less from the viewpoint of smoothly performing a second polymerization step. The molecular weight distribution is more preferably 2.5 or less, still more preferably 2.0 or less, even still more preferably 1.5 or less, and yet even still more preferably 1.3 or less. Further, a lower limit of the molecular weight distribution (Mw/Mn) is usually 1.0.

Note that both Mw and Mn of the polymer block (A) can be measured by gel permeation chromatography (GPC) using sodium polyacrylate as a standard substance. For details of GPC measurement conditions, conditions disclosed in Examples below can be adopted.

### <Polymer Block (B)>

The polymer block (B) is a polymer block different from the polymer block (A), and is a polymer block containing a structural unit derived from the monomer (b) ((meth)acrylic acid ester monomer having a solubility of less than 1 g in 100 g of water at 20° C.). The polymer block (B) can be obtained, for example, by polymerizing a monomer composition containing the monomer (b).

Examples of the monomer (b) include (meth)acrylic acid ester monomers such as (meth)acrylic acid alkyl ester compounds and aromatic (meth)acrylic acid ester compounds.

Among them, in terms of excellent flexibility of the binder, the (meth)acrylic acid alkyl ester compounds and the aromatic (meth)acrylic acid ester compounds are preferable, and the (meth)acrylic acid alkyl ester compounds are more preferable.

Examples of the (meth)acrylic acid alkyl ester compounds include aliphatic alkyl (meth)acrylate and alicyclic alkyl (meth)acrylate.

Examples of the aliphatic alkyl (meth)acrylate include n-butyl (meth)acrylate, isobutyl (meth)acrylate, and 2-ethylhexyl (meth)acrylate, examples of the alicyclic alkyl (meth)acrylate include cyclopentyl (meth)acrylate, cyclohexyl (meth)acrylate, methylcyclohexyl (meth)acrylate, t-butylcyclohexyl (meth)acrylate, cyclodecyl (meth)acrylate, cyclododecyl (meth)acrylate, isobornyl (meth)acrylate, adamantyl (meth)acrylate, dicyclopentenyl (meth)acrylate, dicyclopentenyloxyethyl (meth)acrylate, and dicyclopentanyl (meth)acrylate, and one of them may be used alone, or two or more thereof may be used in combination.

Examples of the aromatic (meth)acrylic acid ester compounds include phenyl (meth)acrylate, phenylmethyl (meth)acrylate, phenylethyl (meth)acrylate, and phenoxyethyl (meth)acrylate, and one of them may be used alone, or two or more thereof may be used in combination.

Here, the block (B) may contain a structural unit derived from a monomer other than the monomer (b) as long as the effect of the present invention is not hindered.

Examples of the monomer other than the monomer (b) include a (meth)acrylic acid ester monomer (hereinafter, also referred to as “monomer (b1)”) having a solubility of 1 g or more in 100 g of water at 20° C., styrenes, and an aliphatic conjugated diene-based monomer, and examples of the monomer (b1) include methyl acrylate, ethyl acrylate, and 2-methoxyethyl acrylate.

Examples of the styrenes include styrene, α-methylstyrene, β-methylstyrene, vinylxylene, vinylnaphthalene, o-methylstyrene, m-methylstyrene, p-methylstyrene, o-ethylstyrene, m-ethylstyrene, p-ethylstyrene, p-n-butylstyrene, p-isobutylstyrene, p-t-butylstyrene, o-methoxystyrene, m-methoxystyrene, p-methoxystyrene, o-chloromethylstyrene, p-chloromethylstyrene, o-chlorostyrene, p-chlorostyrene, o-hydroxystyrene, m-hydroxystyrene, p-hydroxystyrene, and divinylbenzene, and one of them may be used alone, or two or more thereof may be used in combination.

Examples of the aliphatic conjugated diene-based monomer include 2-methyl-1,3-butadiene, 2,3-dimethyl-1,3-butadiene, and 2-chloro-1,3-butadiene, in addition to 1,3-butadiene, and one of them may be used alone, or two or more thereof may be used in combination.

As the monomer (b), the compound having an acryloyl group is preferable in that the polymer having a long primary chain length is obtained due to the high polymerization rate, and the binding force of the binder is improved.

The content of the structural unit derived from the monomer (b) with respect to all structural units of the polymer block (B) is preferably 30 mass % or more, more preferably 40 mass % or more, still more preferably 50 mass % or more, and even still more preferably 70 mass % or more.

By containing the monomer (b) within such a range, the polymer block (B) is a hydrophobic segment, and when the present block polymer is used as the binder, it tends to be easily adsorbed to a surface of, for example, a carbon-based active material. As a result, active materials can be firmly bound to each other, and a secondary battery electrode having excellent binding properties can be obtained.

Here, the solubility in water is preferably 0.8 g or less, more preferably 0.7 g or less, still more preferably 0.6 g or less, even still more preferably 0.5 g or less, and yet even still more preferably 0.4 g or less.

The content of the structural unit derived from the monomer (b) with respect to all the structural units of the polymer block (B) is preferably 40 mass % or more, more preferably 50 mass % or more, still more preferably 60 mass % or more, and even still more preferably less than 70 mass % or more, in terms of being able to obtain the secondary battery electrode having excellent binding properties even under immersion in an electrolytic solution.

The number average molecular weight (Mn) of the polymer block (B) is not particularly limited, but is preferably 1,000 or more. When the number average molecular weight is 1,000 or more, it can be adsorbed to the active material or the like to contribute to improving the binding properties of the electrode.

A glass transition temperature (Tg) of the polymer block (B) is preferably −90° C. or higher from the viewpoint of obtaining good binding properties. The Tg may be, for example, −80° C. or higher, −70° C. or higher, −60° C. or higher, −50° C. or higher, −40° C. or higher, or −30° C. or higher. An upper limit of the Tg is 200° C. due to limitation of constituent monomer units that can be used. The Tg may be, for example, 150° C. or lower, 100° C. or lower, 80° C. or lower, 65° C. or lower, or 50° C. or lower.

Note that in the present specification, the Tg of the polymer block (B) can be obtained by analyzing the block polymer using differential scanning calorimetry (DSC). Here, the Tg of the polymer block (B) is a value based on a structural unit derived from a monomer component containing the monomer (b) of the polymer block (B).

Further, when DSC measurement cannot be performed, the Tg can also be calculated from Tg of homopolymer of each monomer constituting the polymer block using the FOX formula.

### <Present Block Polymer>

The present block copolymer only needs to have at least one each of polymer block (A) and polymer block (B), and examples thereof include (AB) diblock copolymer including the polymer blocks (A) and (B), (ABA) triblock copolymer including polymer block (A)/polymer block (B)/polymer block (A), and (BAB) triblock copolymer.

Further, it may have a structure such as (ABC) or (ABCA) including a polymer block (C) other than the polymer block (A) and the polymer block (B).

Among them, the present block copolymer preferably has an AB structure. Such a structure is suitable in that it is easy to self-emulsify during polymerization and the emulsion can be easily obtained. Note that the AB structure only needs to be present in all or part of the copolymer, and may be, for example, a copolymer having an ABC structure. The present block polymer may be a mixture of two or more kinds of block polymers belonging to the diblock copolymer, the triblock copolymer, and the like. Further, in addition to the block polymer, a polymer composed only of the polymer block (A), a polymer composed only of the polymer block (B), or the like may be contained.

The ratio of the polymer block (A) in the present block copolymer can be 0.1 mass % or more and 90 mass % or less from the viewpoint of binding properties to the electrode and the electrolytic solution swelling resistance. The ratio of the polymer block (A) may be 0.1 mass % or more, 0.5% mass or more, 1 mass % or more, 3 mass % or more, 5 mass % or more, or 10 mass % or more. The ratio of the polymer block (A) may be 90 mass % or less, 80 mass % or less, 70 mass % or less, 60 mass % or less, 50 mass % or less, or 40 mass % or less.

On the other hand, the ratio of the polymer block (B) in the present block polymer can be 10 mass % or more and 99 mass % or less. Within such a range, good binding properties can be exhibited. The ratio of the polymer block (B) may be 10 mass % or more, 30 mass % or more, 50 mass % or more, 60 mass % or more, or 70 mass % or more. The ratio of the polymer block (B) may be 99 mass % or less, 95 mass % or less, 90 mass % or less, or 85 mass % or less.

In the present block polymer, a ratio of a total amount of the polymer block (A) and the polymer block (B) is preferably 60 mass % or more, more preferably 70 mass % or more, still more preferably 80 mass % or more, and even still more preferably 90 mass % or more. The ratio of the total amount of the polymer block (A) and the polymer block (B) may be 100 mass %.

A mass ratio between the polymer block (A) and the polymer block (B) in the present block copolymer is not particularly limited, but can be, for example, 0.1 to 80/20 to 99.9. Within such a range, good binding properties can be exhibited. The mass ratio may be, for example, 0.5 to 70/30 to 99.5, 1.0 to 50/50 to 99, 5.0 to 30/70 to 95, or 10 to 30/70 to 90.

It is preferable that an acid group such as a carboxyl group derived from the ethylenically unsaturated carboxylic acid monomer is neutralized so that degree of neutralization is 40 mol % or more in the present composition, and the present block polymer is used as a salt form. The degree of neutralization is more preferably 50 mol % or more, still more preferably 60 mol % or more, even still more preferably 70 mol % or more, yet even still more preferably 80 mol % or more, and particularly preferably 90 mol % or more. An upper limit of the degree of neutralization is 100 mol %, and may be 98 mol % or less or 95 mol % or less. A range of the degree of neutralization can be determined by appropriately combining the lower limit and the upper limit, and may be, for example, 50 mol % or more and 100 mol % or less, 70 mol % or more and 100 mol % or less, or 80 mol % or more and 100 mol % or less. When the degree of neutralization is 40 mol % or more, it is preferable in that dispersion stability in water is improved. In addition, when the degree of neutralization is 40 mol % or more, since affinity for the electrolytic solution decreases, it is preferable in that the electrolytic solution swelling resistance is improved. In the present specification, the degree of neutralization can be calculated from charged amount values of a monomer having an acid group such as a carboxyl group and a neutralizing agent used for neutralization. Note that the degree of neutralization can be confirmed from an intensity ratio of a peak derived from C═O group of carboxylic acid to a peak derived from C═O group of carboxylate by performing IR measurement of the binder coating film after drying the polymer or a salt thereof at 80° C. for 12 hours under reduced pressure conditions.

The type of salt of the present block polymer is not particularly limited, and examples of the salt include: alkali metal salts such as lithium, sodium, and potassium; alkaline earth metal salts such as a magnesium salt, a calcium salt, and a barium salt; other metal salts such as an aluminum salt; ammonium salts; and organic amine salts. Among them, alkali metal salts and alkaline earth metal salts are preferable, alkali metal salts are more preferable, and lithium salts and potassium salts are still more preferable, from the viewpoint that adverse effects on battery characteristics are unlikely to occur.

### <Emulsion Containing the Present Block Polymer>

The emulsion according to the present invention contains the present block copolymer, and a particle size of the emulsion in water is preferably 100 to 800 nm, more preferably 150 to 650 nm, and still more preferably 150 to 550 nm as a value measured by a laser diffraction/scattering method from the viewpoints of improving the number of binding points and providing excellent binding properties, and of providing excellent dispersion stability of the emulsion.

### <Method for Producing Emulsion Containing the Present Block Polymer>

A method for producing a block polymer having the polymer block (A) and the polymer block (B) includes: a step of producing the polymer block (A) by polymerizing a monomer component containing the ethylenically unsaturated carboxylic acid monomer by a living radical polymerization method; and a step of producing the polymer block (B) by performing emulsion polymerization of a monomer component containing the monomer (b) ((meth)acrylic acid ester monomer having a solubility of less than 1 g in 100 g of water at 20° C.) in the presence of the polymer block (A).

In the emulsion polymerization, a surfactant may be used, but so-called “soap-free polymerization” proceeds by polymerizing a monomer component containing the monomer (b) in the presence of the polymer block (A), and thus a binder containing no surfactant adversely affecting battery performance can be obtained, which is preferable.

Further, in the present production method, the living radical polymerization method is used as described above from the viewpoint that an operation is simple and can be applied to a wide range of monomers.

The method for producing the present block copolymer is not particularly limited as long as the living radical polymerization method is used, and a known production method can be adopted.

Examples of the method include a method of coupling polymers having a functional group. Further, for example, a method of copolymerizing a macromonomer having a polymer block (A) with a monomer constituting the polymer block (B) to obtain a polymer having a structural unit including polymer block (A)/polymer block (B)/polymer block (A) in a molecule thereof is also included.

The living radical polymerization may employ any process such as a batch process, a semi-batch process, a tubular continuous polymerization process, or a continuous stirring tank process (CSTR). Further, the polymerization method can be applied to various modes such as bulk polymerization without using a solvent, solvent-based solution polymerization, aqueous emulsion polymerization, mini-emulsion polymerization, or suspension polymerization. Among them, the emulsion polymerization is preferable from the viewpoint of controllability of polymerization, simplicity of implementation, and obtaining a block polymer excellent in binding property.

The type of living radical polymerization method is also not particularly limited, and various polymerization methods such as a reversible addition-fragmentation chain transfer polymerization method (RAFT method), a nitroxy radical method (NMP method), an atom transfer radical polymerization method (ATRP method), a polymerization method using an organic tellurium compound (TERP method), a polymerization method using an organic antimony compound (SBRP method), a polymerization method using an organic bismuth compound (BIRP method), and an iodine transfer polymerization method can be adopted. Among them, the RAFT method is preferable from the viewpoint of controllability of polymerization, simplicity of implementation, and obtaining the block polymer excellent in binding property.

In the RAFT method, the polymerization proceeds through a reversible chain transfer reaction in the presence of a polymerization control agent (RAFT agent) and a free radical polymerization initiator. Examples of the RAFT agent include a dithioester compound represented by formula (1) or a salt thereof, a trithiocarbonate compound represented by formula (2) or a salt thereof, a dithiocarbamate compound represented by formula (3) or a salt thereof, and a xanthate compound represented by formula (4) or a salt thereof. As the RAFT agent, a monofunctional RAFT agent having only one active point may be used, or a bi- or more-functional RAFT agent may be used.

Further, an amount of the RAFT agent used is appropriately adjusted depending on the type of the monomer to be used, the type of the RAFT agent, and the like.

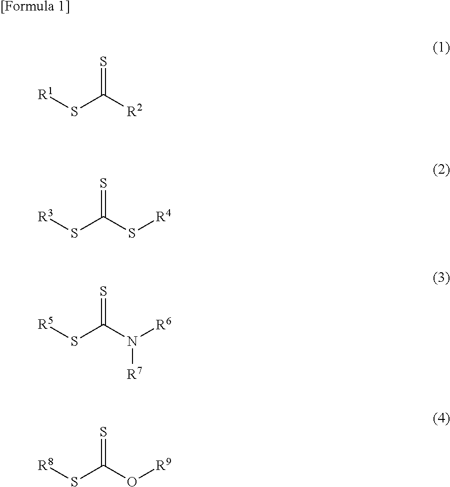

(in the formula, R¹ to R⁹ each represent an alkyl group optionally having a substituent, an aryl group optionally having a substituent, a heteroaryl group optionally having a substituent, or an aralkyl group optionally having a substituent, R⁶ and R⁷ may be bonded to each other to form a ring together with an adjacent nitrogen atom, and the ring may have a substituent)

Examples of the “alkyl group” of the alkyl group optionally having a substituent represented by R¹ to R⁹ include a chain or branched alkyl group having 1 to 16 carbon atoms (the number of carbon atoms is preferably 1 to 12, more preferably 1 to 6, and particularly preferably 1 to 4). Specific examples thereof include a methyl group, an ethyl group, an n-propyl group, and an isopropyl group. When the alkyl group has a substituent, examples of the substituent include a carboxyl group, an ester group (alkoxycarbonyl group and the like), a cyano group, a hydroxyl group, and an alkoxy group. The alkyl group may have 1 to 4 substituents selected from these substituents.

Examples of the “aryl group” of the aryl group optionally having a substituent represented by R¹ to R⁹ include a monocyclic or bicyclic aryl group. Specific examples thereof include a phenyl group, a toluyl group, a xylyl group, and a naphthyl group. When the aryl group has a substituent, examples of the substituent include a carboxyl group, an ester group (alkoxycarbonyl group and the like), a cyano group, a hydroxyl group, an alkoxy group, and a halogen atom. The aryl group may have 1 to 5 substituents selected from these substituents.

Examples of the “heteroaryl group” of the heteroaryl group optionally having a substituent represented by R¹ to R⁹ include a monocyclic or bicyclic heteroaryl group containing at least one heteroatom selected from the group consisting of an oxygen atom, a nitrogen atom, and a sulfur atom as a ring-constituting atom. Specific examples thereof include a pyridyl group, a pyrimidinyl group, and a pyrazinyl group. When the heteroaryl group has a substituent, examples of the substituent include a carboxyl group, an ester group (alkoxycarbonyl group and the like), a cyano group, a hydroxyl group, an alkoxy group, and a halogen atom. The heteroaryl group may have 1 to 4 substituents selected from these substituents.

The “aralkyl group” of the aralkyl group optionally having a substituent represented by R¹ to R⁹ means an alkyl group substituted with an aryl group, and examples thereof include a benzyl group and a phenethyl group. When the aralkyl group has a substituent, examples of the substituent include a carboxyl group, an ester group (alkoxycarbonyl group and the like), a cyano group, a hydroxyl group, an alkoxy group, and a halogen atom. The aryl group in the aralkyl group may have 1 to 5 substituents selected from these substituents.

Further, R⁶ and R⁷ represented in the formula (3) may be bonded to each other to form a ring together with an adjacent nitrogen atom, and the ring may have a substituent. Examples of the ring include a pyrrolidine ring, a piperidine ring, and a morpholine ring. When the ring has a substituent, examples of the substituent include an alkyl group and an oxo group (═O). The ring may have 1 to 3 substituents selected from these substituents.

Here, the RAFT agent in aqueous solution polymerization is preferably a water-soluble RAFT agent, and examples thereof include a compound having a thiocarbonylthio group (—CS—S—) and a hydrophilic group (for example, a carboxyl group) in a molecule thereof and/or a salt thereof.

Examples of salts of the compounds represented by the formulas (1) to (4) include: alkali metal salts (sodium salt, potassium salt, and the like) and ammonium salts when the compounds have an acidic group; and inorganic acid salts such as hydrochloric acid and sulfuric acid and organic acid salts such as carboxylates (acetates and the like) and sulfonates (p-toluenesulfonates and the like) when the compounds have a basic group.

The RAFT agent is preferably a compound represented by the formula (2) or a salt thereof. R³ and R⁴ are the same or different and are preferably the alkyl group optionally having a substituent, further preferably an alkyl group having 1 to 12 carbon atoms (further 1 to 6 carbon atoms) optionally having at least one (particularly 1 to 3) substituent selected from the group consisting of a carboxyl group, an ester group (alkoxycarbonyl group and the like), a cyano group, a hydroxyl group, and an alkoxy group, and particularly preferably an alkyl group having 1 to 4 carbon atoms optionally having one carboxyl group.

Examples of the compound represented by the formula (2) include a group represented by formula (2A) (in the formula, R^{3A} and R^{4A} are the same or different and represent an alkylene group having 1 to 6 carbon atoms (particularly 1 to 4 carbon atoms) optionally having at least one (particularly 1 to 3) substituent selected from the group consisting of an ester group (alkoxycarbonyl group and the like), a cyano group, a hydroxyl group and an alkoxy group). R^{3A} and R^{4A} are preferably an alkylene group having 1 to 3 carbon atoms, and examples of the compound include 2-{[(2-carboxyethyl) sulfanylthiocarbonyl]sulfanyl}propanoic acid and 4-[(2-carboxyethylsulfanylthiocarbonyl) sulfanyl]-4-cyanopentanoic acid.

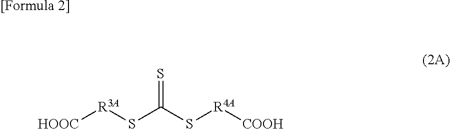

As the polymerization initiator used in the polymerization by the RAFT method, a known radical polymerization initiator such as an azo compound, an organic peroxide, or a persulfate can be used, but the azo compound is preferable from the viewpoint that it is easy to handle for safety and a side reaction during radical polymerization hardly occurs. Examples of the azo compound include 2,2′-azobisisobutyronitrile, 2,2′-azobis(2,4-dimethylvaleronitrile), 2,2′-azobis(4-methoxy-2,4-dimethylvaleronitrile), dimethyl-2,2′-azobis(2-methylpropionate), 2,2′-azobis(2-methylbutyronitrile), 1,1′-azobis(cyclohexane-1-carbonitrile), 2,2′-azobis [N-(2-propenyl)-2-methylpropionamide], 2,2′-azobis(N-butyl-2-methylpropionamide), 4,4′-azobis(4-cyanovaleric acid), 2,2′-azobis [2-(2-imidazolin-2-yl) propane], 2,2′-azobis [2-(2-imidazolin-2-yl) propane]dihydrochloride, 2,2′-azobis [2-(-imidazolin-2-yl) propane]disulfate dihydrate, 2,2′-azobis(2-methylpropionamidine) dihydrochloride, and 2,2′-azobis [N-(2-carboxyethyl)-2-methylpropionamidine]hydrate. Only one of the radical polymerization initiator may be used, or two or more thereof may be used in combination.

Here, the polymerization initiator in the aqueous solution polymerization is preferably a water-soluble polymerization initiator, examples thereof include a compound having a hydrophilic group (for example, a carboxyl group) and/or a salt or hydrate thereof, and among the above, 4,4′-azobis(4-cyanovaleric acid), 2,2′-azobis [2-(2-imidazolin-2-yl) propane]dihydrochloride, 2,2′-azobis [2-(-imidazolin-2-yl) propane]disulfate dihydrate, 2,2′-azobis(2-methylpropionamidine) dihydrochloride, and 2,2′-azobis [N-(2-carboxyethyl)-2-methylpropionamidine]hydrate are preferable.

A use ratio of the radical polymerization initiator is not particularly limited, but from the viewpoint of obtaining a polymer having a smaller molecular weight distribution, an amount of the radical polymerization initiator used with respect to 1 mol of the RAFT agent is preferably 0.5 mol or less, and more preferably 0.2 mol or less. Further, from the viewpoint of stably performing the polymerization reaction, a lower limit of the amount of the radical polymerization initiator used with respect to 1 mol of the RAFT agent is 0.001 mol. Therefore, the amount of the radical polymerization initiator used with respect to 1 mol of the RAFT agent is preferably in a range of 0.001 mol or more and 0.5 mol or less, and more preferably in a range of 0.005 mol or more and 0.2 mol or less.

A reaction temperature in the polymerization reaction by the RAFT method is preferably 30° C. or higher and 120° C. or lower, more preferably 40° C. or higher and 110° C. or lower, and still more preferably 50° C. or higher and 100° C. or lower. When the reaction temperature is 30° C. or higher, the polymerization reaction can be smoothly advanced. On the other hand, when the reaction temperature is 120° C. or lower, the side reaction can be suppressed, and restrictions on usable initiators and solvents are relaxed.

The TERP polymerization method is a method of polymerizing a water-soluble vinyl-based monomer usually in the presence of the organic tellurium compound. For example, Chemical Review, 2009, 109, p. 5051-5068, and the like can be referred to.

The SBPR polymerization method is a method of polymerizing the water-soluble vinyl-based monomer usually in the presence of the organic antimony compound. For example, Chemical Review, 2009, 109, p. 5051-5068, and the like can be referred to.

The BIRP polymerization method is a method of polymerizing a water-soluble vinyl-based monomer usually in the presence of the organic bismuth compound. For example, Chemical Review, 2009, 109, p. 5051-5068, and the like can be referred to.

As the iodine transfer polymerization method, for example, Chemical Review, 2006, 106, p. 3936-3962, and the like can be referred to.

In the present disclosure, a known polymerization solvent can be used in the living radical polymerization. Specific examples of the polymerization solvent include: aromatic compounds such as benzene, toluene, xylene, and anisole; ester compounds such as methyl acetate, ethyl acetate, propyl acetate, and butyl acetate; ketone compounds such as acetone and methyl ethyl ketone; dimethylformamide, acetonitrile, dimethylsulfoxide, alcohols, and water. Only one of the polymerization solvent may be used, or two or more thereof may be used in combination. Among them, water or methanol is preferable from the viewpoint of controllability of polymerization, simplicity of implementation, and obtaining the block polymer excellent in binding property.

Here, from the viewpoint of being able to simplify a production step of an electrode slurry, when a solvent other than water is contained in the polymerization solvent, it is preferable to desolvate dispersion after polymerization and replace the dispersion with water.

The polymer block (A) may be produced by performing the polymerization reaction in the presence of a base compound. A concentration of the monomer may be 13.0 mass % or more, preferably 15.0 mass % or more, more preferably 17.0 mass % or more, still more preferably 19.0 mass % or more, and even still more preferably 20.0 mass % or more, from the viewpoint of improving productivity.

The base compound is a so-called alkaline compound, and either an inorganic base compound or an organic base compound may be used.

Examples of the inorganic base compound include alkali metal hydroxides such as lithium hydroxide, sodium hydroxide, and potassium hydroxide, and alkaline earth metal hydroxides such as calcium hydroxide and magnesium hydroxide, and one or more of them can be used.

Examples of the organic base compound include ammonia and organic amine compounds such as monoethylamine, diethylamine, and triethylamine, and one or more of them can be used. Among them, the alkali metal hydroxide is preferable from the viewpoint of the binding property of the binder containing the polymer or the salt thereof.

The polymer block (B) desirably has a high monomer concentration within a possible range from the viewpoint of improving productivity. The monomer concentration may be 13.0 mass % or more, preferably 15.0 mass % or more, more preferably 17.0 mass % or more, and still more preferably 20.0 mass % or more.

In the present production method, the present block polymer may be neutralized (hereinafter, also referred to as “process neutralization”) by adding an alkaline compound to the dispersion containing the present block polymer obtained after the polymerization reaction. In addition, after the dispersion of the present polymer is obtained without performing the process neutralization, the alkaline compound may be added at the time of preparing the electrode slurry to neutralize (hereinafter, also referred to as “post-neutralization”) the polymer. Among the above, the process neutralization is preferable from the viewpoint of imparting dispersion stability of the emulsion.

### 2. Composition for Secondary Battery Electrode Mixture Layer

The composition for the secondary battery electrode mixture layer of the present invention contains the binder containing the emulsion containing the present block polymer, the active material, and water.

An amount of the present block polymer used in the present composition is, for example, 0.1 parts by mass or more and 20 parts by mass or less with respect to 100 parts by mass of a total amount of the active material. The use amount is, for example, 0.2 parts by mass or more and 10 parts by mass or less, for example, 0.3 parts by mass or more and 8 parts by mass or less, or for example, 0.4 parts by mass or more and 5 parts by mass or less. When the use amount of the present block polymer is less than 0.1 parts by mass, sufficient binding properties may not be obtained. In addition, the dispersion stability of the active material or the like is insufficient, and uniformity of the mixture layer formed may be deteriorated. On the other hand, when the use amount of the present block polymer exceeds 20 parts by mass, the present composition has a high viscosity, and coatability to the current collector may be deteriorated. As a result, spots and irregularities may occur in the obtained mixture layer to adversely affect electrode characteristics.

When the amount of the present block polymer used is within the above range, a composition having excellent dispersion stability of the active material can be obtained, and a mixture layer having extremely high adhesion to the current collector can be obtained, and as a result, durability of the battery is improved. Furthermore, since the present block polymer exhibits sufficiently high binding properties even with a small amount (for example, 5 mass % or less) with respect to the active material and has a carboxy anion, an electrode having low interface resistance and excellent high-rate characteristics can be obtained.

Among the above active materials, a lithium salt of a transition metal oxide can be used as a positive electrode active material, and for example, layered rock salt-type and spinel-type lithium-containing metal oxides can be used. Specific examples of the layered rock salt-type positive electrode active material include lithium cobaltate, lithium nickelate, and NCM {Li(Niₓ,Co_{y},Mn_{z}), x+y+z=1} and NCA {Li(Ni_{1-a-b}COₐAl_{b})}, which are called ternary systems. Further, examples of the spinel-type positive electrode active material include lithium manganate. In addition to the oxides, phosphate, silicate, sulfur, and the like are used, and examples of the phosphate include olivine-type lithium iron phosphate. As the positive electrode active material, one of the above may be used alone, or two or more thereof may be used in combination as a mixture or a composite.

Note that when the positive electrode active material containing the layered rock salt-type lithium-containing metal oxide is dispersed in water, since lithium ions on a surface of the active material and hydrogen ions in water are exchanged, the dispersion exhibits alkalinity. Therefore, aluminum foil (Al) or the like which is a general current collector material for a positive electrode may be corroded. In such a case, it is preferable to neutralize the alkali content eluted from the active material by using the present block polymer which is not neutralized or partially neutralized as the binder. In addition, the use amount of the present block polymer which is not neutralized or partially neutralized is preferably used such that an amount of unneutralized carboxyl groups of the present block polymer is equal to or more than an equivalent amount with respect to an amount of alkali eluted from the active material.

Since all of the positive electrode active materials have low electric conductivity, a conductive auxiliary agent is generally added and used. Examples of the conductive auxiliary agent include carbon-based materials such as carbon black, carbon nanotube, carbon fiber, graphite fine powder, and carbon fiber, and among them, carbon black, carbon nanotube, and carbon fiber are preferable from the viewpoint of easily obtaining excellent conductivity. Further, as the carbon black, Ketjen black and acetylene black are preferable. As the conductive auxiliary agent, one of the above-described ones may be used alone, or two or more thereof may be used in combination. An amount of the conductive auxiliary agent used can be, for example, 0.2 to 20 parts by mass, or for example, 0.2 to 10 parts by mass with respect to 100 parts by mass of the total amount of the active material from the viewpoint of achieving both conductivity and energy density. Further, as the positive electrode active material, a material surface-coated with a conductive carbon-based material may be used.

On the other hand, examples of a negative electrode active material include a carbon-based material, a lithium metal, a lithium alloy, and a metal oxide, and one or more thereof can be used in combination. Among them, the active materials (hereinafter, also referred to as “carbon-based active materials”) including carbon-based materials such as natural graphite, artificial graphite, hard carbon, and soft carbon are preferable, and graphites such as natural graphite and artificial graphite, and hard carbon are more preferable. In addition, in the case of graphite, spheroidized graphite is suitably used from the viewpoint of battery performance, and a preferable range of a particle size of the graphite is, for example, 1 to 20 μm, or for example, 5 to 15 μm. In addition, in order to increase the energy density, a metal, a metal oxide, or the like, capable of absorbing lithium, such as silicon or tin can be used as the negative electrode active material. Among them, silicon has a higher capacity than graphite, and the active materials (hereinafter, also referred to as “silicon-based active material”) including silicon-based materials such as silicon, a silicon alloy, and a silicon oxide such as silicon monoxide (SiO) can be used. However, the silicon-based active material has a high capacity but has a large volume change during charging and discharging. Therefore, it is preferable to use the carbon-based active material in combination. In this case, when a blending amount of the silicon-based active material is large, the electrode material may collapse, and the cycle characteristics (durability) may be greatly deteriorated. From such a viewpoint, when the silicon-based active material is used in combination, a use amount thereof is, for example, 60 mass % or less, or for example, 30 mass % or less with respect to the carbon-based active material.

In the binder containing the present block polymer, the polymer has the structural unit derived from the ethylenically unsaturated carboxylic acid monomer, and the structural unit has high affinity for the silicon-based active material and exhibits good binding properties. Therefore, since the binder of the present invention exhibits excellent binding properties even when a high-capacity type active material containing the silicon-based active material is used, it is considered that the binder of the present invention is also effective for improving the durability of the obtained electrode.

Since the carbon-based active material itself has good electrical conductivity, it is not always necessary to add the conductive auxiliary agent. When the conductive auxiliary agent is added for the purpose of further reducing the resistance, or the like, a use amount thereof is, for example, 10 parts by mass or less, or for example, 5 parts by mass or less, with respect to 100 parts by mass of the total amount of the active material from the viewpoint of the energy density.

When the present composition is in a slurry state, an amount of the active material used is, for example, in a range of 10 to 75 mass %, or for example, in a range of 30 to 65 mass % with respect to a total amount of the present composition. When the amount of the active material used is 10 mass % or more, migration of the binder and the like is suppressed, and it is also advantageous in terms of cost of drying a medium. On the other hand, when the amount of the active material used is 75 mass % or less, fluidity and coatability of the composition can be secured, and a uniform mixture layer can be formed.

Further, when the present composition is prepared in a wet powder state, the amount of the active material used is, for example, in a range of 60 to 97 mass %, or for example, in a range of 70 to 90 mass % with respect to the total amount of the present composition. Further, from the viewpoint of the energy density, it is preferable that an amount of nonvolatile components other than the active material, such as a binder and a conductive auxiliary agent, is as small as possible within a range in which necessary binding property and conductivity are secured.

The present composition uses water as the medium. In addition, for the purpose of adjusting properties, drying properties, and the like of the composition, it may be a mixed solvent with a water-soluble organic solvent such as lower alcohols such as methanol and ethanol, carbonates such as ethylene carbonate, ketones such as acetone, tetrahydrofuran, or N-methylpyrrolidone. A ratio of water in a mixed medium is, for example, 40 mass % or more, or for example, 70 mass % or more.

When the present composition is brought into a coatable slurry state, the content of the medium containing water in the entire composition can be, for example, in a range of 25 to 90 mass %, or for example, 35 to 70 mass %, from the viewpoint of coatability of the slurry, energy cost required for drying, and productivity. Further, in the case of a wet powder state that can be pressed, the content of the medium can be, for example, in a range of 3 to 40 mass %, or for example, in a range of 10 to 30 mass %, from the viewpoint of the uniformity of the mixture layer after pressing.

The binder of the present invention may include only the present block polymer, but other binder components such as a styrene/butadiene-based latex (SBR), an acrylic latex, polyacrylic acid (PAA) or a salt thereof (however, different from the present block polymer), carboxymethyl cellulose (CMC), and a polyvinylidene fluoride-based latex may be used in combination. When another binder component is used in combination, a use amount thereof can be, for example, 0.1 to 5 parts by mass or less, for example, 0.1 to 2 parts by mass or less, or for example, 0.1 to 1 part by mass or less with respect to 100 parts by mass of the total amount of the active material. When the amount of the other binder component used exceeds 5 parts by mass, the resistance may increase, and the high-rate characteristics may be insufficient. Among them, PAA and CMC are preferable from the viewpoint of excellent binding property and electrolytic solution swelling resistance.

The styrene/butadiene-based latex refers to an aqueous dispersion of a copolymer having a structural unit derived from an aromatic vinyl monomer such as styrene and a structural unit derived from an aliphatic conjugated diene-based monomer such as 1,3-butadiene. Examples of the aromatic vinyl monomer include α-methylstyrene, vinyltoluene, and divinylbenzene in addition to styrene, and one or more of them can be used. The structural unit derived from the aromatic vinyl monomer in the copolymer can be, for example, in a range of 20 to 70 mass %, or for example, in a range of 30 to 60 mass %, mainly from the viewpoint of the binding property.

Examples of the aliphatic conjugated diene-based monomer include 2-methyl-1,3-butadiene, 2,3-dimethyl-1,3-butadiene, and 2-chloro-1,3-butadiene in addition to 1,3-butadiene, and one or more of them can be used. The structural unit derived from the aliphatic conjugated diene-based monomer in the copolymer can be, for example, in a range of 30 to 70 mass %, or for example, in a range of 40 to 60 mass %, in that the binding property of the binder and flexibility of the resulting electrode are good.

In addition to the above-described monomers, in order to further improve performance such as the binding property, the styrene/butadiene-based latex may use other monomers as copolymerization monomers, such as nitrile group-containing monomers such as (meth)acrylonitrile, carboxyl group-containing monomers such as (meth)acrylic acid, itanconic acid, maleic acid, and ester group-containing monomers such as methyl (meth)acrylate.

The structural unit derived from the other monomer in the copolymer can be, for example, in a range of 0 to 30 mass %, or for example, in a range of 0 to 20 mass %.

The CMC refers to a substituted product obtained by substituting a nonionic cellulose-based semi-synthetic polymer compound with a carboxymethyl group, and a salt thereof. Examples of the nonionic cellulose-based semi-synthetic polymer compound include: alkyl celluloses such as methyl cellulose, methyl ethyl cellulose, ethyl cellulose, and microcrystalline cellulose;
and hydroxyalkyl celluloses such as hydroxyethyl cellulose, hydroxybutyl methyl cellulose, hydroxypropyl cellulose, hydroxypropyl methyl cellulose, hydroxyethyl methyl cellulose, hydroxypropyl methyl cellulose stearoxy ether, carboxymethyl hydroxyethyl cellulose, alkyl hydroxyethyl cellulose, and nonoxynyl hydroxyethyl cellulose.

The present composition contains the above-described active material, water, and the present binder as essential components, and is obtained by mixing the components using known means. A method for mixing the components is not particularly limited, and a known method can be adopted, but a method is preferable in which powder components such as the active material and the conductive auxiliary agent are dry-blended, then mixed with the present binder and a dispersion medium such as water, and dispersed and kneaded. When the composition for the electrode mixture layer is obtained in the slurry state, it is preferable to finish the composition into a slurry having no poor dispersion or aggregation. As a mixing means, a known mixer such as a planetary mixer, a thin-film swirling mixer, or a rotation-revolution mixer can be used, but it is preferable to use the thin-film swirling mixer in that a good dispersion state can be obtained in a short time. In addition, in the case of using the thin-film swirling mixer, it is preferable to perform preliminary dispersion in advance with a stirrer such as a disper. In addition, viscosity of the slurry can be, for example, in a range of 100 to 10,000 mPa·s as B-type viscosity at 20 rpm, or for example, in a range of 1,000 to 5,000 mPa·s.

On the other hand, when the present composition is obtained in the wet powder state, it is preferable to knead the composition to a uniform state without concentration unevenness using a Henschel mixer, a blender, a planetary mixer, a biaxial kneader, or the like.

### 3. Secondary Battery Electrode

The secondary battery electrode of the present invention includes a mixture layer formed from the present composition on the surface of the current collector such as copper or aluminum. The mixture layer is formed by applying the present composition to the surface of the current collector and then drying and removing the medium such as water. The method for applying the present composition is not particularly limited, and known methods such as a doctor blade method, a dip method, a roll coating method, a comma coating method, a curtain coating method, a gravure coating method, and an extrusion method can be employed. Further, the drying can be performed by a known method such as warm air blowing, decompression, (far) infrared ray irradiation, or microwave irradiation.

Usually, the mixture layer obtained after drying is subjected to compression treatment by a die press, a roll press, or the like. By compressing, the active material and the binder can be brought into close contact with each other, and strength of the mixture layer and adhesion to the current collector can be improved. A thickness of the mixture layer can be adjusted by compression to, for example, about 30 to 80% of that before compression, and the thickness of the mixture layer after compression is generally about 4 to 200 μm.

### 4. Secondary Battery

The secondary battery can be produced by providing the secondary battery electrode of the present invention with a separator and the electrolytic solution. The electrolytic solution may be liquid or gel.

The separator is disposed between the positive electrode and the negative electrode of the battery, and plays a role of preventing a short circuit due to contact between both electrodes and holding the electrolytic solution to ensure the ion conductivity. The separator is preferably a film-like insulating microporous membrane having good ion permeability and mechanical strength. As a specific material, polyolefins such as polyethylene and polypropylene, polytetrafluoroethylene, and the like can be used.

As the electrolytic solution, a known electrolytic solution that is generally used can be used depending on the type of the active material. In a lithium ion secondary battery, specific examples of the solvents include cyclic carbonates having a high dielectric constant and a high electrolyte dissolving ability such as propylene carbonate and ethylene carbonate, and chain carbonates having a low viscosity such as ethyl methyl carbonate, dimethyl carbonate, and diethyl carbonate, and they can be used alone or as a mixed solvent. The electrolytic solution is used by dissolving a lithium salt such as LiPF₆, LiSbF₆, LiBF₄, LiClO₄, or LiAlO₄ in these solvents. In the nickel-hydrogen hydride secondary battery, a potassium hydroxide aqueous solution can be used as the electrolytic solution. The secondary battery is obtained by forming a positive electrode plate and a negative electrode plate separated by the separator into a spiral shape or a laminated structure and storing them in a case or the like.

As described above, the composition for the secondary battery electrode mixture layer (electrode slurry) containing the binder for secondary battery electrodes disclosed in the present specification is good in electrolytic solution swelling resistance, and exhibits excellent binding property to the electrode material in the electrode mixture layer even under immersion in the electrolytic solution, and thus is expected to exhibit good durability (cycle characteristics). Therefore, the secondary battery including the electrode obtained using the binder can ensure good integrity and is expected to exhibit good durability (cycle characteristics) even when charging and discharging are repeated, and is suitable for an in-vehicle secondary battery and the like.

### EXAMPLES

Hereinafter, the present invention will be specifically described based on Examples. Note that the present invention is not limited to these Examples. Hereinafter, “parts” and “%” respectively mean parts by mass and mass % unless otherwise specified.

In Production Examples, the molecular weight distribution of the polymer block (A), a reaction rate of the monomer, a composition ratio of the polymer, the particle size of the emulsion, the glass transition temperature (Tg), and electrolytic solution swelling were evaluated as follows.

### <Measurement of Molecular Weight>

The molecular weight of the block polymer (A) was measured by the gel permeation chromatography (GPC). That is, the number average molecular weight (Mn) and the weight average molecular weight (Mw) in terms of sodium polyacrylate were obtained by aqueous GPC. In addition, the molecular weight distribution (Mw/Mn) was calculated from the obtained values. GPC was performed under the following conditions.

0.1 g of an aqueous solution containing the polymer obtained in Production Example (0.02 g as the solid content of the polymer) was collected and diluted with 40 g of a 0.1M aqueous sodium nitrate solution to obtain a measurement sample. The measurement sample was subjected to gel permeation chromatography (GPC) measurement under conditions described below to obtain the number average molecular weight (Mn) and the weight average molecular weight (Mw) in terms of sodium polyacrylate. In addition, the molecular weight distribution (Mw/Mn) was calculated from the obtained values.

### (GPC Measurement Conditions)

Column: TSKgel GMPW manufactured by Tosoh Corporation ×2 columns
Solvent: 0.1M aqueous sodium nitrate solution
Temperature: 40° C.
Detector: RI
Flow rate: 0.5 mL/min

### <Measurement of Reaction Rate of Monomer>

First, a solution before start of polymerization and a part of a polymerization solution at a predetermined time were sampled and dissolved in methanol to prepare a 4 mass % solution, and then 0.02 g of propylene glycol monomethyl ether as an internal standard substance was added to 4 g of the solution to obtain a measurement sample.

Next, the measurement sample was subjected to gas chromatography (GC) measurement to obtain a monomer concentration X in the solution before the start of polymerization and a monomer concentration Y in the polymerization solution at the predetermined time, and the reaction rate of the monomer was determined by the following formula.

$$Reaction rate of monomer ( \% ) = ( X - Y ) / X \times 100$$

### (GC Measurement Conditions)

Measuring apparatus: Nexis GC-2030 manufactured by Shimadzu Corporation
Column: CP-Wax 52 CB manufactured by Agilent Technologies, Inc.
column length 60 m, column diameter 0.32 mm, df=0.5 μm
Carrier gas: N2
Gas flow rate: 2.0 mL/min
Split ratio: 22.5:1
Injection amount: 1.0 μL
Inlet temperature: 250° C.
Detector: FID
Detector temperature: 250° C.
H₂ flow rate: 32 mL/min
Air flow rate: 280 mL/min
N₂ flow rate: 24 mL/min
Temperature raising condition: 40° C. (3 min)→10° C./min→250° C. (11 min)

### <Measurement of Particle Size>

Particle size distribution of the emulsion containing the block polymer was measured using a laser diffraction/scattering particle size distribution analyzer (Microtrac MT-3300EXII manufactured by MicrotracBell Corp.) using ion-exchanged water as the dispersion medium. When the emulsion was charged in an amount sufficient to obtain an appropriate scattered light intensity to the dispersion in which an excessive amount of dispersion medium was circulating, a particle size distribution shape measured was stabilized after several minutes.

As soon as the stability was confirmed, the particle size distribution was measured to obtain a volume-based median diameter (D50) as a representative value of the particle diameter.

### <Measurement of Glass Transition Temperature (Tg) of Polymer Block (B)>

The glass transition temperature (Tg) of the polymer block (B) of the block polymer contained in the obtained emulsion was determined from an intersection of a baseline and a tangent at an inflection point of a heat flux curve obtained using a differential scanning calorimeter (DSC).

The heat flux line was obtained under conditions that about 5 mg of a sample was cooled to −50° C. and held for 3 minutes, then heated to 150° C. at 10° C./min, subsequently cooled to −50° C., held for 3 minutes, and then heated to 150° C. at 10° C./min.

Here, the Tg obtained under the present measurement conditions is a value based on “the structural unit derived from the monomer component containing the monomer (b)” of the polymer block (B).

### (DSC Measurement Conditions)

Measuring apparatus: DSC 214 Polyma manufactured by NETZSCH
Measurement atmosphere: under nitrogen atmosphere

### <Measurement of Electrolytic Solution Swelling>

The binder containing the emulsion containing the block polymer was poured into a disposable tray, dried at 40° C. for 20 hours, and further vacuum-dried at 80° C. for 12 hours.

The binder coating film obtained after drying was cut into a strip shape of 1 cm×6 cm to prepare a test piece for immersion (hereinafter, also referred to as a “test piece”).

The test piece was immersed in an electrolytic solution mixed at a mass ratio of ethylene carbonate (EC): dimethyl carbonate (DMC)=1:3 and left at 60° C. for 24 hours, then the test piece was taken out from the electrolytic solution, a surface the test piece was wiped off, and the electrolytic solution swelling was measured.

Here, a method for measuring the electrolytic solution swelling will be described below.

When weights of the test piece before and after immersion in the electrolytic solution were respectively defined as [W₀(g)] and [W₁(g)], the electrolytic solution swelling was determined by the following formula.

$$Electrolytic solution swelling ( mass \% ) = ( {W}_{1} ) / ( {W}_{0} ) \times 100$$

Note that it was determined that the lower the electrolytic solution swelling of the binder coating film, the more excellent the electrolytic solution swelling resistance.

### (Determination Criteria for Electrolytic Solution Swelling Resistance)

A: Electrolytic solution swelling is less than 150%
B: Electrolytic solution swelling is 150% or more and less than 180%
C: Electrolytic solution swelling is 180% or more and less than 200%
D: Electrolytic solution swelling is 200% or more, or dissolved in electrolytic solution

### <<Production of Polymer>>

### Production Example 1-1: Production of Polymer F-1

For the polymerization, a reactor equipped with a stirring blade, a thermometer, a reflux condenser, and a nitrogen inlet tube was used.

In a nitrogen atmosphere, 400 parts of water, 100 parts of acrylic acid, and 0.16 parts of 2-(2-carboxyethylsulfanylthiocarbonylsulfanyl) propionic acid (trade name “BM-1429” manufactured by BORON MOLECULAR, Inc.) as the RAFT agent were charged into the reactor and heated to 60° C. 2,2′-azobis(2-methylpropionamidine) dihydrochloride (trade name “V-50” manufactured by FUJIFILM Wako Pure Chemical Corporation, hereinafter also referred to as “V-50”) as the initiator was charged to this solution and reacted until a polymerization conversion rate reached 92% to obtain an aqueous solution of a polymer F-1. The number average molecular weight (Mn) was 140,000, the weight average molecular weight (Mw) was 155,000, and the molecular weight distribution (Mw/Mn) was 1.11.

### Production Examples 1-2 to 1-7: Production of F-2 to F-7

A polymerization reaction solution containing polymers F-2 to F-7 was obtained by performing the same operation as in Production Example 1-1 except that charged amounts of raw materials were changed as shown in Table 1.

The Mw, Mn and Mw/Mn of the polymers F-2 to F-7 were measured in the same manner as in the polymer F-1, and results are shown in Table 1.

TABLE 1

| | | | | Production | Production | Production | Production |
|---|---|---|---|---|---|---|---|
| Production Example No. | | | | Example 1-1 | Example 1-2 | Example 1-3 | Example 1-4 |
| Polymer No. | | | | F-1 | F-2 | F-3 | F-4 |
| First | Charged | Monomer | AA | 100.0 | 100.0 | 100.0 | 60.0 |
| polymerization | amount | | AAm | | | | 40.0 |
| step: | [g] | Polymerization control agent | BM-1429 | 0.16 | 0.50 | 0.08 | 0.16 |
| Polymer | | Polymerization initiator | V-50 | 0.020 | 0.030 | 0.020 | 0.025 |
| block (A) | | Polymerization solvent | Ion-exchanged water | 400.0 | 400.0 | 400.0 | 400.0 |

| | | | | | |
|---|---|---|---|---|---|
| Reaction rate of | AA | 91 | 92 | 90 | 92 |
| monomers [%] | AAm | | | | 90 |
| Polymer block (A) | Content of structural unit | 100 | 100 | 100 | 61 |
| | derived from ethylenically | | | | |

| | | | | |
|---|---|---|---|---|
| unsaturated carboxylic | | | | |
| acid monomer [mass %] | | | | |
| Mn | 140,000 | 47,500 | 258,000 | 150,500 |
| Mw | 155,000 | 57,300 | 321,000 | 175,000 |
| Mw/Mn | 1.11 | 1.21 | 1.24 | 1.16 |

| | | | | Production | Production | Production |
|---|---|---|---|---|---|---|
| Production Example No. | | | | Example 1-5 | Example 1-6 | Example 1-7 |
| Polymer No. | | | | F-5 | F-6 | F-7 |
| First | Charged | Monomer | AA | | 100.0 | 100.0 |
| polymerization | amount | | AAm | 100.0 | | |
| step: | [g] | Polymerization control agent | BM-1429 | 0.16 | 0.25 | 0.12 |
| Polymer | | Polymerization initiator | V-50 | 0.030 | 0.022 | 0.015 |
| block (A) | | Polymerization solvent | Ion-exchanged water | 400.0 | 400.0 | 400.0 |

| | | | | |
|---|---|---|---|---|
| Reaction rate of | AA | | 92 | 92 |
| monomers [%] | AAm | 95 | | |
| Polymer block (A) | Content of structural unit | 0 | 100 | 100 |
| | derived from ethylenically | | | |

| | | | |
|---|---|---|---|
| unsaturated carboxylic | | | |
| acid monomer [mass %] | | | |
| Mn | 161,000 | 105,000 | 203,000 |
| Mw | 195,000 | 123,000 | 250,000 |
| Mw/Mn | 1.21 | 1.17 | 1.23 |

Details of the compounds used in Table 1 are shown below.
AA: acrylic acid
AAm: acrylamide
BM-1429:2-(2-carboxyethylsulfanylthiocarbonylsulfanyl) propionic acid
V-50:2,2′-azobis(2-methylpropionamidine) dihydrochloride

### Production Example 2-1: Production of Block Polymer S-1

For the polymerization, a reactor equipped with a stirring blade, a thermometer, a reflux condenser, and a nitrogen inlet tube was used.

In the nitrogen atmosphere, 160 parts of water, 240 parts of methanol, 17 parts of polymer F-1 in terms of solid content, and 83 parts of cyclohexyl acrylate were added to the reactor and mixed while heating to 55° C. 0.02 parts of V-50 in terms of solid content was added to this solution and reacted until the polymerization conversion rate exceeded 98% to obtain a polymerization reaction solution.

### (Desolvation and Neutralization)

The polymerization reaction solution obtained was desolvated using an evaporator to remove methanol from the polymerization reaction solution. 8.9 parts of lithium hydroxide monohydrate in terms of solid content was added to the emulsion after the desolvation, and neutralization was performed at 90 mol % with respect to an amount of carboxylic acid to obtain an emulsion of a block polymer S-1.

The particle size of the emulsion of S-1 was 480 nm.

### (Physical Properties of Binder Coating Film)

The emulsion of the block polymer S-1 was poured into a disposable tray, dried at 40° C. for 20 hours, and further vacuum-dried at 80° C. for 12 hours.

When the binder coating film obtained after drying was evaluated, the Tg of the polymer block (B) of the block polymer S-1 was 28° C., and the electrolytic solution swelling of the binder coating film was 138%.

### (Production Examples 2-2 to 2-32 and Comparative Production Examples 2-1 and 2-2: Production of Block Polymers S-33 to S-34

Emulsions of block polymers S-2 to S-32 and S-34 and an aqueous solution of block polymer S-33 were obtained by performing the same operation as in Production Example 2-1 except that the charged amounts of the raw materials were changed as shown in Tables 2, 3, and 4.

The particle size of the emulsion, the Tg of each polymer block (B) of the block polymers S-2 to S-34, and the electrolytic solution swelling of the binder coating film were evaluated in the same manner as in the block polymer S-1, and results are shown in Tables 2, 3, and 4.

TABLE 2

| | | | | | Production | Production | Production | Production | Production |
|---|---|---|---|---|---|---|---|---|---|
| | | | | | Example | Example | Example | Example | Example |
| Production Example No. | | | | | 2-1 | 2-2 | 2-3 | 2-4 | 2-5 |
| Block polymer No. | | | | | S-1 | S-2 | S-3 | S-4 | S-5 |
| Second | Charged | Monomer (b) | CHA | Solubility in water: <0.1 | 83.0 | 83.0 | 83.0 | 83.0 | |
| polymerization | amount | | | [g/100 g of water] | | | | | |
| step: Polymer | [parts] | | BA | Solubility in water: 0.14 | | | | | 83.0 |
| block (B) | | | | [g/100 g of water] | | | | | |
| | | | 2-EHA | Solubility in water: <0.1 | | | | | |
| | | | | [g/100 g of water] | | | | | |
| | | | IBXA | Solubility in water: <0.1 | | | | | |
| | | | | [g/100 g of water] | | | | | |
| | | Monomer (b1) | MEA | Solubility in water: 11.6 | | | | | |
| | | | | [g/100 g of water] | | | | | |

| Ratio of monomer (b) [mass %] | | 100% | 100% | 100% | 100% | 100% |
|---|---|---|---|---|---|---|
| Polymer block (A) | Polymer No. | F-1 | F-1 | F-1 | F-1 | F-1 |
| | parts | 17.0 | 17.0 | 17.0 | 17.0 | 17.0 |
| Crosslinkable monomer | NMMA | | | | | |
| Polymerization initiator | V-50 | 0.02 | 0.02 | 0.02 | 0.02 | 0.02 |
| Polymerization solvent | Ion-exchanged water | 160 | 160 | 160 | 160 | 160 |
| | Methanol | 240 | 240 | 240 | 240 | 240 |

| | | | | | | |
|---|---|---|---|---|---|---|
| Reaction rate of | CHA 99 | 99 | 99 | 99 | 99 | |
| monomers [%] | BA | | | | | 97 |

2-EHA
IBXA
MEA

| Process | Charged amount | LiOH•H₂O | 8.9 | | 4.9 | | 8.9 |
|---|---|---|---|---|---|---|---|
| neutralization | [parts] | NaOH | | 8.5 | | | |
| | Neutralization salt | Type | Li | Na | Li | — | Li |
| | | Degree of neutralization | 90 | 90 | 50 | 0 | 90 |
| | | [mol %] | | | | | |
| Block | Ratio of polymer block | Polymer block (A) | 16 | 16 | 16 | 16 | 17 |
| polymer | (mass %) * Calculated value | Polymer block (B) | 84 | 84 | 84 | 84 | 83 |
| | based on the above reaction | | | | | | |
| | Particle size of emulsion containing | | 480 | 480 | 480 | 475 | 420 |
| | block polymer [nm] | | | | | | |
| | Tg of polymer block (B) [° C.] | | 28 | 28 | 26 | 25 | −50 |
| Evaluation | Electrolytic solution | Electrolytic solution swelling | 137.8 | 138.2 | 140.7 | 180.4 | 166.5 |
| results | resistance of | resistance [%] | | | | | |
| | binder coating film | Determination | A | A | A | C | B |

| | | | | | Production | Production | Production | Production |
|---|---|---|---|---|---|---|---|---|
| | | | | | Example | Example | Example | Example |
| Production Example No. | | | | | 2-6 | 2-7 | 2-8 | 2-9 |
| Block polymer No. | | | | | S-6 | S-7 | S-8 | S-9 |
| Second | Charged | Monomer (b) | CHA | Solubility in water: <0.1 | | | 55.0 | 66.0 |
| polymerization | amount | | | [g/100 g of water] | | | | |
| step: Polymer | [parts] | | BA | Solubility in water: 0.14 | | | | |
| block (B) | | | | [g/100 g of water] | | | | |
| | | | 2-EHA | Solubility in water: <0.1 | 83.0 | | 28.0 | 17.0 |
| | | | | [g/100 g of water] | | | | |
| | | | IBXA | Solubility in water: <0.1 | | 83.0 | | |
| | | | | [g/100 g of water] | | | | |
| | | Monomer (b1) | MEA | Solubility in water: 11.6 | | | | |
| | | | | [g/100 g of water] | | | | |
| | | Ratio of monomer (b) [mass %] | | | 100% | 100% | 100% | 100% |
| | | Polymer block (A) | Polymer No. | | F-1 | F-1 | F-1 | F-1 |
| | | | parts | | 17.0 | 17.0 | 17.0 | 17.0 |
| | | Crosslinkable monomer | NMMA | | | | | |
| | | Polymerization initiator | V-50 | | 0.02 | 0.02 | 0.02 | 0.02 |
| | | Polymerization solvent | Ion-exchanged water | | 160 | 160 | 160 | 160 |
| | | | Methanol | | 240 | 240 | 240 | 240 |
| | Reaction rate of | | CHA 99 | | | | 98 | 98 |
| | monomers [%] | | BA | | | | 98 | |
| | | 2-EHA | | | 96 | | | 99 |
| | | IBXA | | | | 98 | | |
| | | MEA | | | | | | |
| Process | Charged amount | | LiOH•H₂O | | 8.9 | 8.9 | 8.9 | 8.9 |
| neutralization | [parts] | | NaOH | | | | | |
| | Neutralization salt | | Type | | Li | Li | Li | Li |
| | | | Degree of neutralization | | 90 | 90 | 90 | 90 |
| | | | [mol %] | | | | | |
| Block | Ratio of polymer block | | Polymer block (A) | | 17 | 16 | 23 | 16 |
| polymer | (mass %) * Calculated value | | Polymer block (B) | | 83 | 84 | 77 | 84 |
| | based on the above reaction | | | | | | | |
| | Particle size of emulsion containing | | | | 330 | 300 | 460 | 240 |
| | block polymer [nm] | | | | | | | |
| | Tg of polymer block (B) [° C.] | | | | −60 | 105 | −16 | 8 |
| Evaluation | Electrolytic solution | | Electrolytic solution swelling | | 119.6 | 128.5 | 128.6 | 134.1 |
| results | resistance of | | resistance [%] | | | | | |
| | binder coating film | | Determination | | A | A | A | A |
| | | | | | Production | Production | Production | Production |
| | | | | | Example | Example | Example | Example |
| Production Example No. | | | | | 2-10 | 2-11 | 2-12 | 2-13 |
| Block polymer No. | | | | | S-10 | S-11 | S-12 | S-13 |
| Second | Charged | Monomer (b) | CHA | Solubility in water: <0.1 | 55.0 | 55.0 | 83.0 | 83.0 |
| polymerization | amount | | | [g/100 g of water] | | | | |
| step: Polymer | [parts] | | BA | Solubility in water: 0.14 | | | | |
| block (B) | | | | [g/100 g of water] | | | | |
| | | | 2-EHA | Solubility in water: <0.1 | | | | |
| | | | | [g/100 g of water] | | | | |
| | | | IBXA | Solubility in water: <0.1 | 28.0 | | | |
| | | | | [g/100 g of water] | | | | |
| | | Monomer (b1) | MEA | Solubility in water: 11.6 | | 28.0 | | |
| | | | | [g/100 g of water] | | | | |

| Ratio of monomer (b) [mass %] | | 100% | 66% | 100% | 100% |
|---|---|---|---|---|---|
| Polymer block (A) | Polymer No. | F-1 | F-1 | F-2 | F-3 |
| | parts | 17.0 | 17.0 | 17.0 | 17.0 |
| Crosslinkable monomer | NMMA | | | | |
| Polymerization initiator | V-50 | 0.02 | 0.02 | 0.02 | 0.02 |
| Polymerization solvent | Ion-exchanged water | 160 | 160 | 160 | 160 |
| | Methanol | 240 | 240 | 240 | 240 |

| | | | | | |
|---|---|---|---|---|---|
| Reaction rate of | CHA 99 | 99 | 99 | 99 | 97 |
| monomers [%] | BA | | | | |

| | | |
|---|---|---|
| 2-EHA | | |
| IBXA | 99 | |
| MEA | | 97 |

| Process | Charged amount | LiOH•H₂O | 8.9 | 8.9 | 8.9 | 8.9 |
|---|---|---|---|---|---|---|
| neutralization | [parts] | NaOH | | | | |
| | Neutralization salt | Type | Li | Li | Li | Li |
| | | Degree of neutralization | 90 | 90 | 90 | 90 |
| | | [mol %] | | | | |
| Block | Ratio of polymer block | Polymer block (A) | 16 | 16 | 16 | 17 |
| polymer | (mass %) * Calculated value | Polymer block (B) | 84 | 84 | 84 | 83 |
| | based on the above reaction | | | | | |
| | Particle size of emulsion containing | | 420 | 550 | 140 | 620 |
| | block polymer [nm] | | | | | |
| | Tg of polymer block (B) [° C.] | | 40 | −15 | 28 | 28 |
| Evaluation | Electrolytic solution | Electrolytic solution swelling | 135.2 | 182.5 | 136.0 | 143.6 |
| results | resistance of | resistance [%] | | | | |
| | binder coating film | Determination | A | C | A | A |

TABLE 3

| | | | | | Production | Production | Production | Production |
|---|---|---|---|---|---|---|---|---|
| | | | | | Example | Example | Example | Example |
| Production Example No. | | | | | 2-14 | 2-15 | 2-16 | 2-17 |
| Block polymer No. | | | | | S-14 | S-15 | S-16 | S-17 |
| Second | Charged | Monomer (b) | CHA | Solubility in water: <0.1 | 83.0 | 90.0 | 70.0 | 40.0 |
| polymerization | amount | | | [g/100 g of water] | | | | |
| step: Polymer | [parts] | | BA | Solubility in water: 0.14 | | | | |
| block (B) | | | | [g/100 g of water] | | | | |
| | | | 2-EHA | Solubility in water: <0.1 | | | | |
| | | | | [g/100 g of water] | | | | |
| | | | IBXA | Solubility in water: <0.1 | | | | |
| | | | | [g/100 g of water] | | | | |
| | | Monomer (b1) | MEA | Solubility in water: 11.6 | | | | |
| | | | | [g/100 g of water] | | | | |

| Ratio of monomer (b) [mass %] | | 100% | 100% | 100% | 100% |
|---|---|---|---|---|---|
| Polymer | Polymer No. | F-4 | F-1 | F-1 | F-1 |
| block (A) | parts | 17.0 | 10.0 | 30.0 | 60.0 |
| Crosslinkable monomer | NMMA | | | | |
| Polymerization initiator | V-50 | 0.02 | 0.02 | 0.02 | 0.02 |
| Polymerization solvent | Ion-exchanged water | 160 | 160 | 160 | 160 |
| | Methanol | 240 | 240 | 240 | 240 |

| | | | | | | |
|---|---|---|---|---|---|---|
| | Reaction rate of | CHA | 99 | 99 | 99 | 98 |
| | monomers [%] | BA | | | | |
| | | 2-EHA | | | | |
| | | IBXA | | | | |
| | | MEA | | | | |
| Process | Charged amount | LiOH•H₂O | 5.3 | 5.2 | 15.7 | 31.4 |
| neutralization | [parts] | NaOH | | | | |

| | | | | | |
|---|---|---|---|---|---|
| Neutralization | Type | Li | Li | Li | Li |
| salt | Degree of neutralization | 90 | 90 | 90 | 90 |
| | [mol %] | | | | |

| Block | Ratio of polymer block | Polymer block (A) | 16 | 10 | 29 | 57 |
|---|---|---|---|---|---|---|
| polymer | (mass %) * Calculated | | | | | |
| | value based on the above | Polymer block (B) | 84 | 90 | 71 | 43 |
| | Particle size of emulsion | | 460 | 680 | 260 | 130 |
| | containing block polymer [nm] | | | | | |
| | Tg of polymer block (B) [° C.] | | 29 | 26 | 31 | 35 |
| Evaluation | Electrolytic solution | Electrolytic solution swelling | 145.6 | 152.5 | 103.5 | 102.0 |
| results | resistance of binder | resistance [%] | | | | |
| | coating film | Determination | A | B | A | A |

| | | | | | Production | Production | Production |
|---|---|---|---|---|---|---|---|
| | | | | | Example | Example | Example |
| Production Example No. | | | | | 2-18 | 2-19 | 2-20 |
| Block polymer No. | | | | | S-18 | S-19 | S-20 |
| Second | Charged | Monomer (b) | CHA | Solubility in water: <0.1 | 95.0 | 99.0 | 83.0 |
| polymerization | amount | | | [g/100 g of water] | | | |
| step: Polymer | [parts] | | BA | Solubility in water: 0.14 | | | |
| block (B) | | | | [g/100 g of water] | | | |
| | | | 2-EHA | Solubility in water: <0.1 | | | |
| | | | | [g/100 g of water] | | | |
| | | | IBXA | Solubility in water: <0.1 | | | |
| | | | | [g/100 g of water] | | | |
| | | Monomer (b1) | MEA | Solubility in water: 11.6 | | | |
| | | | | [g/100 g of water] | | | |
| | | Ratio of monomer (b) [mass %] | | | 100% | 100% | 100% |
| | | Polymer | Polymer No. | | F-2 | F-2 | F-1 |
| | | block (A) | parts | | 5.0 | 1.0 | 17.0 |
| | | Crosslinkable monomer | NMMA | | | | |
| | | Polymerization initiator | V-50 | | 0.04 | 0.05 | 0.02 |
| | | Polymerization solvent | Ion-exchanged water | | 160 | 160 | 240 |
| | | | Methanol | | 240 | 240 | 160 |
| | Reaction rate of | | CHA | | 98 | 97 | 99 |
| | monomers [%] | | BA | | | | |
| | | | 2-EHA | | | | |
| | | | IBXA | | | | |
| | | | MEA | | | | |
| Process | Charged amount | | LiOH•H₂O | | 2.6 | 0.5 | 8.9 |
| neutralization | [parts] | | NaOH | | | | |
| | Neutralization | Type | | | Li | Li | Li |
| | salt | Degree of neutralization | | | 90 | 90 | 90 |
| | | [mol %] | | | | | |
| Block | Ratio of polymer block | | Polymer block (A) | | 5 | 1 | 16 |
| polymer | (mass %) * Calculated | | | | | | |
| | value based on the above | | Polymer block (B) | | 95 | 99 | 84 |
| | Particle size of emulsion | | | | 360 | 790 | 160 |
| | containing block polymer [nm] | | | | | | |
| | Tg of polymer block (B) [° C.] | | | | 25 | 24 | 28 |
| Evaluation | Electrolytic solution | | Electrolytic solution swelling | | 174.0 | 184.0 | 137.4 |
| results | resistance of binder | | resistance [%] | | | | |
| | coating film | | Determination | | B | C | A |
| | | | | | Production | Production | Production |
| | | | | | Example | Example | Example |
| Production Example No. | | | | | 2-21 | 2-22 | 2-23 |
| Block polymer No. | | | | | S-21 | S-22 | S-23 |
| Second | Charged | Monomer (b) | CHA | Solubility in water: <0.1 | 83.0 | 83.0 | 83.0 |
| polymerization | amount | | | [g/100 g of water] | | | |
| step: Polymer | [parts] | | BA | Solubility in water: 0.14 | | | |
| block (B) | | | | [g/100 g of water] | | | |
| | | | 2-EHA | Solubility in water: <0.1 | | | |
| | | | | [g/100 g of water] | | | |
| | | | IBXA | Solubility in water: <0.1 | | | |
| | | | | [g/100 g of water] | | | |
| | | Monomer (b1) | MEA | Solubility in water: 11.6 | | | |
| | | | | [g/100 g of water] | | | |
| | | Ratio of monomer (b) [mass %] | | | 100% | 100% | 100% |
| | | Polymer | Polymer No. | | F-1 | F-1 | F-1 |
| | | block (A) | parts | | 17.0 | 17.0 | 17.0 |
| | | Crosslinkable monomer | NMMA | | | | |
| | | Polymerization initiator | V-50 | | 0.02 | 0.02 | 0.02 |
| | | Polymerization solvent | Ion-exchanged water | | 280 | 120 | 80 |
| | | | Methanol | | 120 | 280 | 320 |
| | Reaction rate of | | CHA | | 98 | 98 | 99 |
| | monomers [%] | | BA | | | | |
| | | | 2-EHA | | | | |
| | | | IBXA | | | | |
| | | | MEA | | | | |
| Process | Charged amount | | LiOH•H₂O | | 8.9 | 8.9 | 8.9 |
| neutralization | [parts] | | NaOH | | | | |
| | Neutralization | Type | | | Li | Li | Li |
| | salt | Degree of neutralization | | | 90 | 90 | 90 |
| | | [mol %] | | | | | |
| Block | Ratio of polymer block | | Polymer block (A) | | 16 | 16 | 16 |
| polymer | (mass %) * Calculated | | | | | | |
| | value based on the above | | Polymer block (B) | | 84 | 84 | 84 |
| | Particle size of emulsion | | | | 120 | 560 | 740 |
| | containing block polymer [nm] | | | | | | |
| | Tg of polymer block (B) [° C.] | | | | 28 | 28 | 28 |
| Evaluation | Electrolytic solution | | Electrolytic solution swelling | | 138.5 | 155.5 | 187.0 |
| results | resistance of binder | | resistance [%] | | | | |
| | coating film | | Determination | | A | B | C |
| | | | | | Production | Production | Production |
| | | | | | Example | Example | Example |
| Production Example No. | | | | | 2-24 | 2-25 | 2-26 |
| Block polymer No. | | | | | S-24 | S-25 | S-26 |
| Second | Charged | Monomer (b) | CHA | Solubility in water: <0.1 | 83.0 | 41.5 | 41.5 |
| polymerization | amount | | | [g/100 g of water] | | | |
| step: Polymer | [parts] | | BA | Solubility in water: 0.14 | | | |
| block (B) | | | | [g/100 g of water] | | | |
| | | | 2-EHA | Solubility in water: <0.1 | | 41.5 | 41.5 |
| | | | | [g/100 g of water] | | | |
| | | | IBXA | Solubility in water: <0.1 | | | |
| | | | | [g/100 g of water] | | | |
| | | Monomer (b1) | MEA | Solubility in water: 11.6 | | | |
| | | | | [g/100 g of water] | | | |

| Ratio of monomer (b) [mass %] | | 100% | 100% | 100% |
|---|---|---|---|---|
| Polymer | Polymer No. | F-1 | F-6 | F-7 |
| block (A) | parts | 17.0 | 17.0 | 17.0 |
| Crosslinkable monomer | NMMA | 0.8 | | |
| Polymerization initiator | V-50 | 0.02 | 0.02 | 0.02 |
| Polymerization solvent | Ion-exchanged water | 80 | 160 | 160 |
| | Methanol | 320 | 240 | 240 |

| | | | | | |
|---|---|---|---|---|---|
| | Reaction rate of | CHA | 97 | 99 | 98 |
| | monomers [%] | BA | | | |
| | | 2-EHA | | 99 | 99 |
| | | IBXA | | | |
| | | MEA | | | |
| Process | Charged amount | LiOH•H₂O | 8.9 | 8.9 | 8.9 |
| neutralization | [parts] | NaOH | | | |

| | | | | |
|---|---|---|---|---|
| Neutralization | Type | Li | Li | Li |
| salt | Degree of neutralization | 90 | 90 | 90 |
| | [mol %] | | | |

| Block | Ratio of polymer block | Polymer block (A) | 17 | 17 | 17 |
|---|---|---|---|---|---|
| polymer | (mass %) * Calculated | | | | |
| | value based on the above | Polymer block (B) | 83 | 83 | 83 |
| | Particle size of emulsion | | 470 | 350 | 600 |
| | containing block polymer [nm] | | | | |
| | Tg of polymer block (B) [° C.] | | 29 | 28 | 29 |
| Evaluation | Electrolytic solution | Electrolytic solution swelling | 138.2 | 140.9 | 145.5 |
| results | resistance of binder | resistance [%] | | | |
| | coating film | Determination | A | A | A |

TABLE 4

| | | | | | Production | Production | Production |
|---|---|---|---|---|---|---|---|
| | | | | | Example | Example | Example |
| Production Example No., Comparative Production Example No. | | | | | 2-27 | 2-28 | 2-29 |
| Block polymer No. | | | | | S-27 | S-28 | S-29 |
| Second | Charged | Monomer (b) | CHA | Solubility in water: <0.1 | 41.5 | 41.5 | 41.5 |
| polymerization | amount | | | [g/100 g of water] | | | |
| step: Polymer | [parts] | | BA | Solubility in water: 0.14 | 41.5 | 41.5 | 41.5 |
| block (B) | | | | [g/100 g of water] | | | |
| | | | 2-EHA | Solubility in water: <0.1 | | | |
| | | | | [g/100 g of water] | | | |
| | | | IBXA | Solubility in water: <0.1 | | | |
| | | | | [g/100 g of water] | | | |
| | | Monomer (b1) | MEA | Solubility in water: 11.6 | | | |
| | | | | [g/100 g of water] | | | |
| | | Ratio of monomer (b) [mass %] | | | 100% | 100% | 100% |
| | | Polymer | Polymer No. | | F-7 | F-7 | F-7 |
| | | block (A) | parts | | 17.0 | 17.0 | 17.0 |
| | | Crosslinkable monomer | NMMA | | | | |
| | | Polymerization initiator | V-50 | | 0.02 | 0.02 | 0.02 |
| | | Polymerization solvent | Ion-exchanged water | | 160 | 160 | 160 |
| | | | Methanol | | 240 | 240 | 240 |
| | Reaction rate of | | CHA | | 97 | 97 | 96 |
| | monomers [%] | | BA | | 99 | 99 | 99 |
| | | | 2-EHA | | | | |
| | | | IBXA | | | | |
| | | | MEA | | | | |
| Process | Charged amount | | LiOH•H₂O | | 1.5 | 4.0 | 6.4 |
| neutralization | [parts] | | NaOH | | | | |
| | Neutralization | Type | | | Li | Li | Li |
| | salt | Degree of neutralization [mol %] | | | 15 | 40 | 65 |
| Block | Ratio of polymer block | | Polymer block (A) | | 17 | 17 | 17 |
| polymer | (mass %) * Calculated | | | | | | |
| | value based on the above | | Polymer block (B) | | 83 | 83 | 83 |
| | Particle size of emulsion containing | | | | 600 | 600 | 600 |
| | block polymer [nm] | | | | | | |
| | Tg of polymer block (B) [° C.] | | | | 29 | 29 | 28 |
| Evaluation | Electrolytic solution | | Electrolytic solution | | 145.5 | 131.1 | 143.1 |
| results | resistance of binder | | swelling resistance [%] | | | | |
| | coating film | | Determination | | A | A | A |
| | | | | | Production | Production | Production |
| | | | | | Example | Example | Example |
| Production Example No., Comparative Production Example No. | | | | | 2-30 | 2-31 | 2-32 |
| Block polymer No. | | | | | S-30 | S-31 | S-32 |
| Second | Charged | Monomer (b) | CHA | Solubility in water: <0.1 | 41.5 | 41.5 | 41.5 |
| polymerization | amount | | | [g/100 g of water] | | | |
| step: Polymer | [parts] | | BA | Solubility in water: 0.14 | 41.5 | | |
| block (B) | | | | [g/100 g of water] | | | |
| | | | 2-EHA | Solubility in water: <0.1 | | 41.5 | |
| | | | | [g/100 g of water] | | | |
| | | | IBXA | Solubility in water: <0.1 | | | |
| | | | | [g/100 g of water] | | | |
| | | Monomer (b1) | MEA | Solubility in water: 11.6 | | | 41.5 |
| | | | | [g/100 g of water] | | | |

| Ratio of monomer (b) [mass %] | | 100% | 100% | 100% |
|---|---|---|---|---|
| Polymer | Polymer No. | F-7 | F-7 | F-7 |
| block (A) | parts | 17.0 | 17.0 | 17.0 |
| Crosslinkable monomer | NMMA | | | |
| Polymerization initiator | V-50 | 0.02 | 0.02 | 0.02 |
| Polymerization solvent | Ion-exchanged water | 240 | 160 | 280 |
| | Methanol | 160 | 240 | 120 |

| | | | | | |
|---|---|---|---|---|---|
| | Reaction rate of | CHA | 96 | 99 | 99 |
| | monomers [%] | BA | 98 | | |
| | | 2-EHA | | 99 | |
| | | IBXA | | | |
| | | MEA | | | 99 |
| Process | Charged amount | LiOH•H₂O | 8.9 | 4.0 | 4.0 |
| neutralization | [parts] | NaOH | | | |

| | | | | |
|---|---|---|---|---|
| Neutralization | Type | Li | Li | Li |
| salt | Degree of neutralization [mol %] | 90 | 40 | 40 |

| Block | Ratio of polymer block | Polymer block (A) | 17 | 17 | 17 |
|---|---|---|---|---|---|
| polymer | (mass %) * Calculated | | | | |
| | value based on the above | Polymer block (B) | 83 | 83 | 83 |
| | Particle size of emulsion containing | | 600 | 260 | 150 |
| | block polymer [nm] | | | | |
| | Tg of polymer block (B) [° C.] | | −13 | −26 | −11 |
| Evaluation | Electrolytic solution | Electrolytic solution | 137.8 | 126.8 | 195.3 |
| results | resistance of binder | swelling resistance [%] | | | |
| | coating film | Determination | A | A | C |

| | | | | | Comparative | Comparative |
|---|---|---|---|---|---|---|
| | | | | | Production | Production |
| Production Example No., Comparative Production Example No. | | | | | Example 2-1 | Example 2-2 |
| Block polymer No. | | | | | S-33 | S-34 |
| Second | Charged | Monomer (b) | CHA | Solubility in water: <0.1 | | 83.0 |
| polymerization | amount | | | [g/100 g of water] | | |
| step: Polymer | [parts] | | BA | Solubility in water: 0.14 | | |
| block (B) | | | | [g/100 g of water] | | |
| | | | 2-EHA | Solubility in water: <0.1 | | |
| | | | | [g/100 g of water] | | |
| | | | IBXA | Solubility in water: <0.1 | | |
| | | | | [g/100 g of water] | | |
| | | Monomer (b1) | MEA | Solubility in water: 11.6 | 83.0 | |
| | | | | [g/100 g of water] | | |

| Ratio of monomer (b) [mass %] | | 0% | 100% |
|---|---|---|---|
| Polymer | Polymer No. | F-1 | F-5 |
| block (A) | parts | 17.0 | 17.0 |
| Crosslinkable monomer | NMMA | | |
| Polymerization initiator | V-50 | 0.02 | 0.02 |
| Polymerization solvent | Ion-exchanged water | 400 | 400 |
| | Methanol | | |

| | | | | |
|---|---|---|---|---|
| | Reaction rate of | CHA | | 96 |
| | monomers [%] | BA | | |
| | | 2-EHA | | |
| | | IBXA | | |
| | | MEA | 98 | |
| Process | Charged amount | LiOH•H₂O | 8.5 | |
| neutralization | [parts] | NaOH | | |

| | | | |
|---|---|---|---|
| Neutralization | Type | Li | — |
| salt | Degree of neutralization [mol %] | 90 | — |

| Block | Ratio of polymer block | Polymer block (A) | 16 | 17 |
|---|---|---|---|---|
| polymer | (mass %) * Calculated | | | |
| | value based on the above | Polymer block (B) | 84 | 83 |
| | Particle size of emulsion containing | | Aqueous | Aggregation |
| | block polymer [nm] | | solution | |
| | Tg of polymer block (B) [° C.] | | −45 | 31 |
| Evaluation | Electrolytic solution | Electrolytic solution | 205.5 | 138.5 |
| results | resistance of binder | swelling resistance [%] | | |
| | coating film | Determination | D | A |

The details of the compounds used in Tables 2, 3, and 4 are shown below.
CHA: cyclohexyl acrylate
2-EHA: 2-ethylhexyl acrylate
BA: n-butyl acrylate
IBXA: isobornyl acrylate
MEA: 2-methoxyethyl acrylate
NMMA: N-methylol methacrylamide
V-50:2,2′-azobis(2-methylpropionamidine) dihydrochloride

### Synthesis Example 1: Synthesis of Aqueous Lithium Polyacrylate Solution

Lithium hydroxide monohydrate in an amount corresponding to 90 mol % of carboxylic acid and pure water were added to a 18 mass % aqueous solution of polyacrylic acid (trade name “AC-10H” manufactured by Toagosei Co., Ltd.) to obtain a 15 mass % aqueous solution of lithium polyacrylate (hereinafter, also referred to as “PAALi”).

### Example 1

### (Preparation of Composition for Electrode Mixture Layer (Electrode Slurry))

As the active material, artificial graphite (trade name “SCMG-CF” manufactured by Showa Denko K.K.) and SiO (5 μm manufactured by OSAKA Titanium Technologies Co., Ltd.) were used. As the binder, a mixture of the block polymer S-1, PAALi obtained in Synthesis Example 1, and sodium carboxymethylcellulose (hereinafter referred to as “CMC”) was used.

Artificial graphite, SiO, block polymer S-1, PAALi, and CMC were added using water as a diluting solvent to a planetary mixer (HIVIS MIX 2P-03 type manufactured by PRIMIX Corporation) at a mass ratio of artificial graphite:SiO:block polymer S-1:PAALi:CMC=76.8:19.2:2.0:1.0:1.0 (solid content) so that solid content concentration of the composition for the electrode mixture layer was 49 mass %, and the mixture was mixed for 1 hour and 30 minutes to prepare a composition for an electrode mixture layer in a slurry state (electrode slurry).

### (Preparation of Negative Electrode Plate)

Subsequently, the electrode slurry was applied onto a current collector (copper foil) having a thickness of 16.5 μm using a variable applicator, and dried in a ventilation dryer at 80° C. for 15 minutes to form a mixture layer. Thereafter, the mixture layer was rolled to have a thickness of 50±5 μm and a mixture density of 1.60±0.10 g/cm³, and then punched into a size of 1.0 cm×6.0 cm for a peeling strength test and 3 cm square for battery evaluation to obtain a negative electrode plate.

### (Preparation of Positive Electrode Plate)

In an N-methylpyrrolidone (NMP) solvent, 100 parts of LiNi_{0.5}Co_{0.2}Mn_{0.3}O₂ (NCM) as the positive electrode active material and 2 parts of acetylene black were mixed and added, and 4 parts of polyvinylidene fluoride (PVDF) as a binder for the positive electrode was mixed to prepare a composition for a positive electrode mixed material layer. The composition for the positive electrode mixed material layer was applied to an aluminum current collector (thickness: 20 μm) and dried to form a mixture layer. Thereafter, the mixture layer was rolled to have a thickness of 125 μm and a mixture density of 3.0 g/cm³, and then punched into a 3 cm square to obtain a positive electrode plate.

### (Preparation of Electrolytic Solution)

Vinylene carbonate (VC) and fluoroethylene carbonate (FEC) were respectively added to be 1 mass % and 2 mass % to a mixed solvent containing ethylene carbonate (EC) and dimethyl carbonate (DMC) (EC:DMC=3:7 by volume), and 1.2 mol/L of LiPF₆ was dissolved to prepare a nonaqueous electrolyte.

### (Preparation of Secondary Battery)

For configuration of the battery, a lead terminal was attached to each of the positive and negative electrodes, and electrode bodies opposed to each other with a separator (made of polyethylene: film thickness 16 μm, porosity 47%) interposed therebetween were placed in a battery exterior body using an aluminum laminate, injected with liquid, and sealed to obtain a test battery. Note that a design capacity of this prototype battery is 50 mAh. As the design capacity of the battery, the battery was designed based on an end-of-charge voltage up to 4.2 V.

### <Evaluation of Cycle Characteristics>

The lithium ion secondary battery of a laminate type cell prepared above was subjected to a charge/discharge operation at a charge/discharge rate of 0.1 C under a condition of 2.5 to 4.2 V by CC discharge under an environment of 45° C., and an initial capacity Co was measured. Further, charging and discharging were repeated at a charge/discharge rate of 0.5 C under the condition of 2.5 to 4.2 V by CC discharge in an environment of 45° C., and a capacity C100 after 100 cycles was measured.

Here, the cycle characteristics (ΔC) were determined by the following formula.

$$Δ C = {C}_{100} / {C}_{0} \times 100 ( \% )$$

ΔC calculated by the above formula was 82.0%, and the cycle characteristics based on the following criteria were evaluated as “A”.

Note that the larger the value of AC, the more excellent the cycle characteristics.

### (Determination Criteria for Cycle Characteristics)

A: Charge/discharge capacity retention rate is 75% or more
B: Charge/discharge capacity retention rate is 60% or more and less than 75%
C: Charge/discharge capacity retention rate is 45% or more and less than 60%
D: Charge/discharge capacity retention rate is 30% or more and less than 45%
E: Charge/discharge capacity retention rate is less than 30%

### Examples 2 to 33 and Comparative Examples 1 and 2

An electrode slurry was prepared by performing the same operation as in Example 1 except for using formulation shown in Tables 5 and 6. The cycle characteristics of the battery of the negative electrode plate obtained using each electrode slurry were evaluated, and results are shown in Tables 5 and 6.

TABLE 5

| | | | | Example | Example | Example | Example | Example | Example | Example |
|---|---|---|---|---|---|---|---|---|---|---|
| Example No. | | | | 1 | 2 | 3 | 4 | 5 | 6 | 7 |
| Composition | Active | Artificial | parts | 76.8 | 76.8 | 76.8 | 76.8 | 76.8 | 76.8 | 76.8 |
| for | material | graphite | | | | | | | | |
| electrode | | SiO | parts | 19.2 | 19.2 | 19.2 | 19.2 | 19.2 | 19.2 | 19.2 |
| mixture | Binder | Block | No. | S-1 | S-1 | S-2 | S-3 | S-4 | S-5 | S-6 |
| layer | | polyner | parts | 2.0 | 3.0 | 2.0 | 2.0 | 2.0 | 2.0 | 2.0 |
| (Electrode | | | (solid content) | | | | | | | |
| slurry) | | PAALi | parts | 1.0 | 0.0 | 1.0 | 1.0 | 1.0 | 1.0 | 1.0 |
| | | CMC | parts | 1.0 | 2.0 | 1.0 | 1.0 | 1.0 | 1.0 | 1.0 |

| | Ion-exchanged water | | 100 | 89 | 100 | 100 | 100 | 100 | 100 |
|---|---|---|---|---|---|---|---|---|---|
| | Total charged amount | | 200.0 | 190.0 | 200.0 | 200.0 | 200.0 | 200.0 | 200.0 |
| | Solid content | | 49% | 52% | 49% | 49% | 49% | 49% | 49% |
| | concentration [mass %] | | | | | | | | |
| Evaluation | Cycle | Capacity | 83% | 75% | 76% | 79% | 55% | 66% | 60% |
| results | characteristics | retention | | | | | | | |

| | | | | | | | |
|---|---|---|---|---|---|---|---|
| rate [%] | | | | | | | |
| Determination | A | A | A | A | C | B | B |

| | | | | Example | Example | Example | Example | Example | Example |
|---|---|---|---|---|---|---|---|---|---|
| Example No. | | | | 8 | 9 | 10 | 11 | 12 | 13 |
| Composition | Active | Artificial | parts | 76.8 | 76.8 | 76.8 | 76.8 | 76.8 | 76.8 |
| for | material | graphite | | | | | | | |
| electrode | | SiO | parts | 19.2 | 19.2 | 19.2 | 19.2 | 19.2 | 19.2 |
| mixture | Binder | Block | No. | S-7 | S-8 | S-9 | S-10 | S-11 | S-12 |
| layer | | polyner | parts | 2.0 | 2.0 | 2.0 | 2.0 | 2.0 | 2.0 |
| (Electrode | | | (solid content) | | | | | | |
| slurry) | | PAALi | parts | 1.0 | 1.0 | 1.0 | 1.0 | 1.0 | 1.0 |
| | | CMC | parts | 1.0 | 1.0 | 1.0 | 1.0 | 1.0 | 1.0 |

| | Ion-exchanged water | | 100 | 100 | 100 | 100 | 100 | 100 |
|---|---|---|---|---|---|---|---|---|
| | Total charged amount | | 200.0 | 200.0 | 200.0 | 200.0 | 200.0 | 200.0 |
| | Solid content | | 49% | 49% | 49% | 49% | 49% | 49% |
| | concentration [mass %] | | | | | | | |
| Evaluation | Cycle | Capacity | 55% | 77% | 80% | 74% | 50% | 75% |
| results | characteristics | retention | | | | | | |

| | | | | | | |
|---|---|---|---|---|---|---|
| rate [%] | | | | | | |
| Determination | C | A | A | B | C | A |

| | | | | Example | Example | Example | Example | Example |
|---|---|---|---|---|---|---|---|---|
| Example No. | | | | 14 | 15 | 16 | 17 | 18 |
| Composition | Active | Artificial | parts | 76.8 | 76.8 | 76.8 | 76.8 | 76.8 |
| for | material | graphite | | | | | | |
| electrode | | SiO | parts | 19.2 | 19.2 | 19.2 | 19.2 | 19.2 |
| mixture | Binder | Block | No. | S-13 | S-14 | S-15 | S-16 | S-17 |
| layer | | polyner | parts | 2.0 | 2.0 | 2.0 | 2.0 | 2.0 |
| (Electrode | | | (solid content) | | | | | |
| slurry) | | PAALi | parts | 1.0 | 1.0 | 1.0 | 1.0 | 1.0 |
| | | CMC | parts | 1.0 | 1.0 | 1.0 | 1.0 | 1.0 |

| | Ion-exchanged water | | 100 | 100 | 100 | 100 | 100 |
|---|---|---|---|---|---|---|---|
| | Total charged amount | | 200.0 | 200.0 | 200.0 | 200.0 | 200.0 |
| | Solid content | | 49% | 49% | 49% | 49% | 49% |
| | concentration [mass %] | | | | | | |
| Evaluation | Cycle | Capacity | 76% | 68% | 72% | 51% | 37% |
| results | characteristics | retention | | | | | |

| | | | | | |
|---|---|---|---|---|---|
| rate [%] | | | | | |
| Determination | A | B | B | C | D |

TABLE 6

| | | | | Example | Example | Example | Example | Example | Example | Example |
|---|---|---|---|---|---|---|---|---|---|---|
| Example No., Comparative Example No. | | | | 19 | 20 | 21 | 22 | 23 | 24 | 25 |
| Composition | Active | Artificial | parts | 76.8 | 76.8 | 76.8 | 76.8 | 76.8 | 76.8 | 76.8 |
| for | material | graphite | | | | | | | | |
| electrode | | SiO | parts | 19.2 | 19.2 | 19.2 | 19.2 | 19.2 | 19.2 | 19.2 |
| mixture | Binder | Block | No. | S-18 | S-19 | S-20 | S-21 | S-22 | S-23 | S-24 |
| layer | | polyner | parts | 2.0 | 2.0 | 2.0 | 2.0 | 2.0 | 2.0 | 2.0 |
| (Electrode | | | (solid content) | | | | | | | |
| slurry) | | PAALi | parts | 1.0 | 1.0 | 1.0 | 1.0 | 1.0 | 1.0 | 1.0 |
| | | CMC | parts | 1.0 | 1.0 | 1.0 | 1.0 | 1.0 | 1.0 | 1.0 |

| | Ion-exchanged water | | 100 | 100 | 100 | 100 | 100 | 100 | 100 |
|---|---|---|---|---|---|---|---|---|---|
| | Total charged amount | | 200.0 | 200.0 | 200.0 | 200.0 | 200.0 | 200.0 | 200.0 |
| | Solid content | | 49% | 49% | 49% | 49% | 49% | 49% | 49% |
| | concentration [mass %] | | | | | | | | |
| Evaluation | Cycle | Capacity | 58% | 56% | 81% | 70% | 72% | 55% | 62% |
| results | characteristics | retention | | | | | | | |

| | | | | | | | |
|---|---|---|---|---|---|---|---|
| rate [%] | | | | | | | |
| Determination | C | C | A | B | B | C | B |

| | | | | Example | Example | Example | Example | Example |
|---|---|---|---|---|---|---|---|---|
| Example No., Comparative Example No. | | | | 26 | 27 | 28 | 29 | 30 |
| Composition | Active | Artificial | parts | 76.8 | 76.8 | 76.8 | 76.8 | 76.8 |
| for | material | graphite | | | | | | |
| electrode | | SiO | parts | 19.2 | 19.2 | 19.2 | 19.2 | 19.2 |
| mixture | Binder | Block | No. | S-25 | S-26 | S-27 | S-28 | S-29 |
| layer | | polyner | parts | 2.0 | 2.0 | 2.0 | 2.0 | 2.0 |
| (Electrode | | | (solid content) | | | | | |
| slurry) | | PAALi | parts | 1.0 | 1.0 | 1.0 | 1.0 | 1.0 |
| | | CMC | parts | 1.0 | 1.0 | 1.0 | 1.0 | 1.0 |

| | Ion-exchanged water | | 100 | 100 | 100 | 100 | 100 |
|---|---|---|---|---|---|---|---|
| | Total charged amount | | 200.0 | 200.0 | 200.0 | 200.0 | 200.0 |
| | Solid content | | 49% | 49% | 49% | 49% | 49% |
| | concentration [mass %] | | | | | | |
| Evaluation | Cycle | Capacity | 76% | 80% | 70% | 81% | 82% |
| results | characteristics | retention | | | | | |

| | | | | | |
|---|---|---|---|---|---|
| rate [%] | | | | | |
| Determination | A | A | B | A | A |

| | | | | Example | Example | Example | Comparative | Comparative |
|---|---|---|---|---|---|---|---|---|
| Example No., Comparative Example No. | | | | 31 | 32 | 33 | Example 1 | Example 2 |
| Composition | Active | Artificial | parts | 76.8 | 76.8 | 76.8 | 76.8 | 76.8 |
| for | material | graphite | | | | | | |
| electrode | | SiO | parts | 19.2 | 19.2 | 19.2 | 19.2 | 19.2 |
| mixture | Binder | Block | No. | S-30 | S-31 | S-32 | S-33 | S-34 |
| layer | | polyner | parts | 2.0 | 2.0 | 2.0 | 2.0 | 2.0 |
| (Electrode | | | (solid content) | | | | | |
| slurry) | | PAALi | parts | 1.0 | 1.0 | 1.0 | 1.0 | 1.0 |
| | | CMC | parts | 1.0 | 1.0 | 1.0 | 1.0 | 1.0 |

| | Ion-exchanged water | | 100 | 100 | 100 | 100 | 120 |
|---|---|---|---|---|---|---|---|
| | Total charged amount | | 200.0 | 200.0 | 200.0 | 200.0 | 220.0 |
| | Solid content | | 49% | 49% | 49% | 49% | 45% |
| | concentration [mass %] | | | | | | |
| Evaluation | Cycle | Capacity | 86% | 64% | 45% | 10% | 33% |
| results | characteristics | retention | | | | | |

| | | | | | |
|---|---|---|---|---|---|
| rate [%] | | | | | |
| Determination | C | B | C | E | D |

### <<Evaluation Results>>

As is apparent from the results of Examples 1 to 33, the composition for the secondary battery electrode mixture layer (electrode slurry) containing the binder for secondary battery electrodes of the present invention exhibited good electrolytic solution swelling resistance and contributed to improvement of the cycle characteristics.

Among them, focusing on the content of the structural unit derived from the monomer (b) of the polymer block (B), when the monomer (b) (BA, CHA, 2-EHA, or IBXA) was contained in an amount of 50 mass % or more, the electrolytic solution swelling was kept low, and good cycle characteristics were exhibited (Examples 1 and 6 to 12).

Further, when focusing on the Tg of the polymer block (B) of the block polymer, particularly good results were shown when the Tg was in a range of lower than 50° C. (Examples 1, 6, 7, and 9 to 12). This is considered to be because sufficient flexibility was imparted to the coating film due to moderately low Tg, and the coating film had toughness capable of withstanding expansion and contraction of the active material.

Furthermore, focusing on a ratio of the polymer block (A) to the polymer block (B) in the block polymer, particularly good cycle characteristics were exhibited when the ratio of the polymer block (A) was in a range of 5% (Example 19) to 30% (Example 17) (Examples 1 and 16~20). It is considered that when the ratio of the polymer block (A) in the block polymer was 5% or more, the electrolytic solution swelling could be kept low, and sufficient active material binding properties were maintained even in the electrolytic solution. In addition, this is considered to be because since the ratio of the polymer block (A) in the block polymer was 30% or less, the flexibility of the binder was improved, and the binder had toughness capable of withstanding expansion and contraction of the active material.

Furthermore, focusing on the degree of neutralization of the carboxylic acid, 40% to 90% neutralization (Examples 1, 4, 29, and 30) exhibited better electrolytic solution swelling resistance and cycle characteristics than non-neutralization (Example 5). This is considered to be because the affinity for the electrolytic solution decreased by the presence of the carboxylate.

In addition, focusing on the particle size of the emulsion containing the block polymer, the cycle characteristics were improved in a particle size range of 120 nm (Example 22) to 740 nm (Example 24), and in particular, the cycle characteristics were further improved in a particle size range of 160 nm (Example 21) to 560 nm (Example 23). It is considered that when the particle size was 740 nm or less, the number of particles increased, and since the number of binding points increased, the binding property of the binder to the active material was improved and good cycle characteristics were exhibited. In addition, it is considered that when the particle size was 120 nm or more, the binder was less likely to be non-uniform due to aggregation, and the active material binding properties were sufficiently exhibited, and thus the cycle characteristics were improved.

In contrast, when the MEA as the monomer (b1) was used without using the monomer (b) (Comparative Example 1), the electrolytic solution swelling was very large, and the cycle characteristics were deteriorated. This is considered to be because the swelling of the binder deteriorated the binding property.

Further, when the polymer block (A) in the block polymer did not contain a structural unit derived from an ethylenically unsaturated carboxylic acid monomer (Comparative Example 2), the cycle characteristics were deteriorated. This is considered to be because electrostatic repulsion due to the carboxylic acid (salt) was eliminated, the emulsion was easily aggregated, and the binder was likely to be non-uniform.

### INDUSTRIAL APPLICABILITY

The composition for the secondary battery electrode mixture layer (electrode slurry) containing the binder for secondary battery electrodes of the present invention has a low slurry viscosity, and exhibits excellent binding property to the electrode material and excellent adhesiveness to the current collector in the electrode mixture layer, and thus is expected to exhibit good durability (cycle characteristics). Therefore, the secondary battery including the electrode obtained using the binder is expected to exhibit good durability (cycle characteristics), and is expected to be applied to the in-vehicle secondary battery. In addition, it is also useful for use of an active material containing silicon, and is expected to contribute to an increase in capacity of the battery.

The binder for secondary battery electrodes of the present invention can be particularly suitably used for a nonaqueous electrolyte secondary battery electrode, and is particularly useful for a nonaqueous electrolyte lithium ion secondary battery having high energy density.

1. A binder for secondary battery electrodes comprising an emulsion containing a block polymer having a polymer block (A) and a polymer block (B), wherein
the polymer block (A) contains a structural unit derived from an ethylenically unsaturated carboxylic acid monomer, and
the polymer block (B) contains a structural unit derived from a (meth)acrylic acid ester monomer (hereinafter referred to as “monomer (b)”) having a solubility of less than 1 g in 100 g of water at 20° C.

2. The binder for secondary battery electrodes according to claim 1, wherein a ratio of the polymer block (A) in the block polymer is 1 mass % or more and 50 mass % or less.

3. The binder for secondary battery electrodes according to claim 1, wherein the polymer block (A) contains a structural unit derived from an ethylenically unsaturated carboxylic acid monomer in an amount of 50 mass % or more with respect to all structural units of the polymer block (A).

4. The binder for secondary battery electrodes according to claim 1, wherein the polymer block (B) contains a structural unit derived from the monomer (b) in an amount of 50 mass % or more with respect to all structural units of the polymer block (B).

5. The binder for secondary battery electrodes according to claim 1, wherein the block polymer does not contain a structural unit derived from a crosslinkable monomer.

6. The binder for secondary battery electrodes according to claim 1, wherein the block polymer is a salt obtained by neutralizing 40 mol % or more of carboxyl groups of the block polymer.

7. The binder for secondary battery electrodes according to claim 1, wherein a particle size of the emulsion is 100 to 800 nm as a value measured by a laser diffraction/scattering method.

8. A composition for a secondary battery electrode mixture layer, the composition comprising the binder for secondary battery electrodes according to claim 1, an active material, and water.

9. A composition for a secondary battery electrode mixture layer, the composition comprising the binder for secondary battery electrodes according to claim 6, an active material, and water.

10. A secondary battery electrode comprising a mixture layer formed from the composition for the secondary battery electrode mixture layer according to claim 8 on a surface of a current collector.

11. A secondary battery electrode comprising a mixture layer formed from the composition for the secondary battery electrode mixture layer according to claim 9 on a surface of a current collector.

12. A secondary battery comprising the secondary battery electrode according to claim 11.

13. A method for producing a secondary battery electrode binder containing an emulsion containing a block polymer, wherein
the block polymer has a polymer block (A) and a polymer block (B), and
the method comprises:
a step of producing the polymer block (A) by polymerizing a monomer component containing an ethylenically unsaturated carboxylic acid monomer by a living radical polymerization method; and
a step of producing the polymer block (B) by performing emulsion polymerization of a monomer component containing a (meth)acrylic acid ester monomer having a solubility of less than 1 g in 100 g of water at 20° C. in the presence of the polymer block (A).

14. The method for producing the secondary battery electrode binder according to claim 13, wherein the living radical polymerization method is a reversible addition-fragmentation chain transfer polymerization method (RAFT method).

15. The method for producing the secondary battery electrode binder according to claim 13, wherein the emulsion polymerization is soap-free polymerization.

16. The binder for secondary battery electrodes according to claim 2, wherein the polymer block (A) contains a structural unit derived from an ethylenically unsaturated carboxylic acid monomer in an amount of 50 mass % or more with respect to all structural units of the polymer block (A).

17. The binder for secondary battery electrodes according to claim 2, wherein the polymer block (B) contains a structural unit derived from the monomer (b) in an amount of 50 mass % or more with respect to all structural units of the polymer block (B).

18. The binder for secondary battery electrodes according to claim 2, wherein the block polymer does not contain a structural unit derived from a crosslinkable monomer.

19. The binder for secondary battery electrodes according to claim 2, wherein the block polymer is a salt obtained by neutralizing 40 mol % or more of carboxyl groups of the block polymer.

20. The binder for secondary battery electrodes according to claim 2, wherein a particle size of the emulsion is 100 to 800 nm as a value measured by a laser diffraction/scattering method.
